(19) United States
(12) Patent Application Publication
(10) Pub. No.: US 2012/0092379 A1
(43) Pub. Date: Apr. 19, 2012

(54) SENSING DATA DISPLAY APPARATUS AND SENSING DATA PROCESSING SYSTEM

(75) Inventors: Satomi TSUJI, Koganei (JP); Nobuo Sato, Saitama (JP); Kazuo Yano, Hino (JP); Koji Ara, Higashiyamato (JP); Tomoaki Akitomi, Kokubunji (JP); Rieko Otsuka, Fuchu (JP)

(73) Assignee: Hitachi, Ltd.

(21) Appl. No.: 13/271,325

(22) Filed: Oct. 12, 2011

(30) Foreign Application Priority Data
Oct. 15, 2010 (JP) 2010-232083

(51) Int. Cl. G09G 5/00; G06F 15/16

(52) U.S. Cl. 345/660; 345/156; 709/206

(57) ABSTRACT

It is provided a sensing data display apparatus which displays a sensing data with regard to a human, the sensing data display apparatus comprising: a receiving module for receiving a data indicating a physical amount detected by a sensor terminal mounted by the human; a sensing data storing module for storing the data indicating the physical amount; an information creating module for creating a piece of information related to the sensor terminal from the data stored to the sensing data storing module; a display module for displaying the piece of information; and a viewer detecting module for detecting a viewer who locates at a vicinity of the sensing display apparatus. The display module displays the piece of information related to a piece of information of the viewer detected by the viewer detecting module.

### CLAIM OF PRIORITY

The present application claims priority from Japanese patent application JP 2010-232083 filed on Oct. 15, 2010, the content of which is hereby incorporated by reference into this application.

### BACKGROUND OF THE INVENTION

This invention relates to a technology of displaying an activity data of a person which is acquired by a sensor terminal.

By a remarkable development in a storage technology or a sensor technology in recent years, it has been enabled to record a human routine activity as a digital data without restricting the activity. For example, projects have been increased for recording a human activity by sensors (camera, microphone, acceleration sensor, infrared ray sensor and the like) mounted to a human body or inside a room, which is referred to as a life log. However, a large amount of collected real world data as they are cannot be turned to practical use for improving lives or business of persons (users) per se from whom the data are sampled. The data need to be processed in a display which is easy to understand and fed back to the users.

In related arts, JP 2005-309609 A and JP 2006-53684 A disclose technologies of rearranging to display human motion logs which are acquired by digital apparatus of sensors and the like. Further, JP 2009-146364 A discloses a technology of identifying a viewer by a noncontact IC card and displaying a communication box for the viewer. Further, JP 2009-295067 A discloses a technology of switching displays in accordance with a number of persons who are proximate to a display apparatus.

### SUMMARY OF THE INVENTION

There are much data which are acquired by sensor terminals, and there are various display formats depending on a processing system. Time and labor of a user which are required for viewing are therefore enormous.

The representative one of inventions disclosed in this application is outlined as follows.

There is provided a sensing data display apparatus which displays a sensing data with regard to a human, the sensing data display apparatus comprising: a receiving module for receiving a data indicating a physical amount detected by a sensor terminal mounted by the human; a sensing data storing module for storing the data indicating the physical amount; an information creating module for creating a piece of information related to the sensor terminal from the data stored to the sensing data storing module; a display module for displaying the piece of information; and a viewer detecting module for detecting a viewer who locates at a vicinity of the sensing display apparatus. The display module displays the piece of information related to a piece of information of the viewer detected by the viewer detecting module.

According to an embodiment of this invention, a viewer can predominantly see information which is highly related to the viewer per se from a large amount of sensing data and data processed therefrom by mounting sensor terminals for acquiring the data and viewing the data. The viewer can find necessary information at once, and therefore, this invention can also achieve an effect of capable of accelerating to view the data.

### BRIEF DESCRIPTION OF THE DRAWINGS

The present invention can be appreciated by the description which follows in conjunction with the following figures, wherein:

FIG. 1 is an explanatory diagram showing an example of a configuration of a sensing data display apparatus and a scene of utilizing;

FIG. 2 is a block diagram showing an example of configurations of a client, a personal client, and an application server;

FIG. 3 is a block diagram showing an example of configurations of a business information control server, a sensor net server, and a base station;

FIG. 4 is a block diagram showing a an example of configuration of a terminal;

FIG. 5 is a sequence diagram showing an example of sequence until a sensing data is stored to a sensor net server;

FIG. 6 is a sequence diagram showing an example of sequence of forming basic content of an application server;

FIG. 7 is a sequence diagram showing an example of sequence when a client displays a screen;

FIG. 8 is a flowchart showing a processing of determining a viewer;

FIG. 9 is an explanatory diagram showing an example of a screen of emphasizing a display;

FIG. 10 is an explanatory diagram showing an example of a screen of emphasizing a display;

FIG. 11 is an explanatory diagram showing an example of a user ID correspondence table;

FIG. 12 is an explanatory diagram showing an example of an acceleration data table;

FIG. 13A is an explanatory diagram showing an example of a meeting table;

FIG. 13B is an explanatory diagram showing an example of a meeting table;

FIG. 14 is an explanatory diagram showing an example of an access control convention;

FIG. 15 is an explanatory diagram showing an example of a screen displaying a sensing data;

FIG. 16A is an explanatory diagram showing an example of a screen of selecting content;

FIG. 16B is an explanatory diagram showing an example of a screen of selecting content;

FIG. 17 is a sequence diagram showing an example of sequence when a result of transmitting and receiving a mail is displayed on a screen;

FIG. 18 is an explanatory diagram showing an example of content of a mail which is automatically transmitted;

FIG. 19 is an explanatory diagram showing an example of a screen including a mail reply result;

FIG. 20 is an explanatory diagram showing an example of a screen including a mail reply result;

FIG. 21 is an explanatory diagram showing an example of a secondary database; and

FIG. 22 is an explanatory diagram showing an example of a motion rhythm tapestry.

### DETAILED DESCRIPTION OF THE PREFERRED EMBODIMENTS

This invention is a sensing data display apparatus of displaying a sensing data, which is featured in detecting a viewer viewing the display apparatus, and changing to display a screen content in accordance with an individual of viewers or a configuration of members thereof. An explanation will be given thereof in reference to the drawings as follows. Further, the display apparatus determines an accessibility of an access to content of sensing data which can be displayed by the member configuration of viewers, and displays a link only to an accessible content on a screen (described in a second embodiment).

### First Embodiment

First, an explanation will be given of a first embodiment of this invention in reference to the drawings. The first embodiment is featured in emphasizing to display a portion related to a viewer in a screen. Specifically, an emphasizing module is marked, changed in a color thereof, enlarged to display, or moved to a center of the screen or the like. In the embodiment, a representative method of emphasizing is disclosed, however, the other will do. Thereby, a viewer can also acquire a desired piece of information in a shorter period of time.

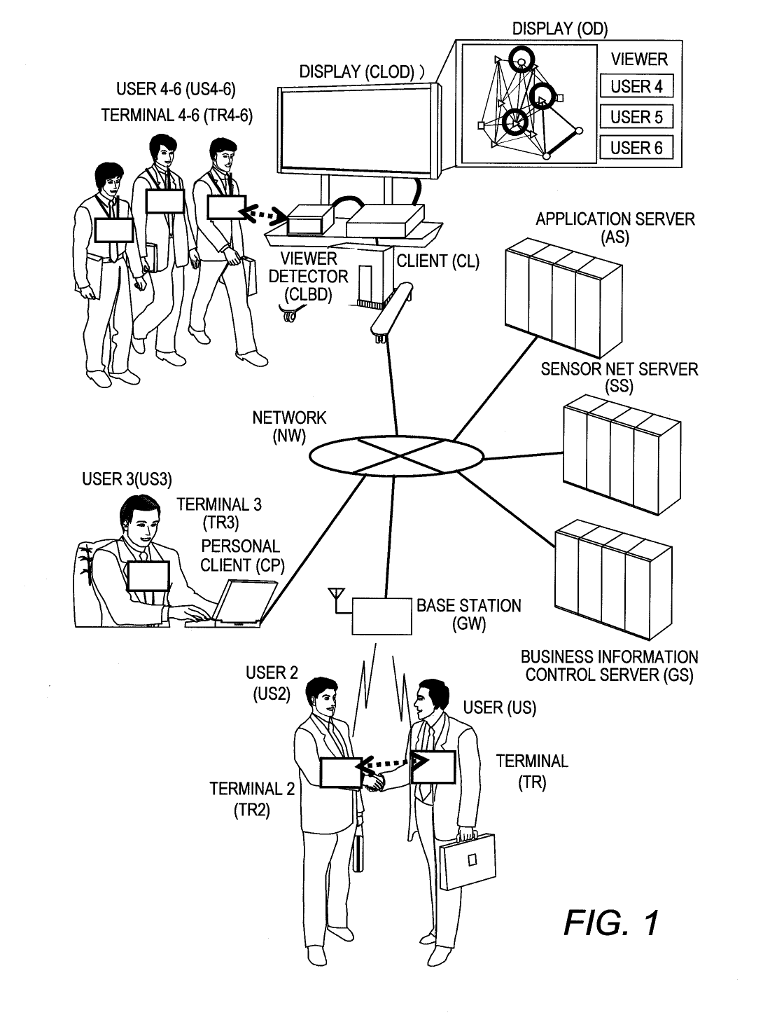

### <FIG. 1: Total Processing Flow>

FIG. 1 shows an outline of a system according to the first embodiment. According to the first embodiment, a member of an organization wears a sensor terminal (TR, TR2-6: hereinafter, designated as TR in all of cases where individuals are not identified) as a user (US: US2-6: hereinafter, designated as US in all of cases where individuals are not identified), and acquires sensing data with regard to motions of respective members or interactions among members by the terminal (TR). With regard to the interaction, when users (US) meet each other, the meeting is detected by transmitting and receiving infrared rays among respective terminals (TR). The acquired sensing data are connected by wireless or wire and are transmitted to a base station (GW), and are stored to a sensor net server (SS) via a network (NW). The sensor net server (SS) periodically prepares the sensing data and saves the sensing data as secondary data. When content (frequently, images, however, other data of lime-varying images, text data, voice data or the like will do) are created for showing the content to a user, an application server (SS) acquires the secondary data from the sensor net server (AS) periodically and creates content. In a necessary case, an access is made to a business information control server (GS) accumulated with information of service time or service record, schedule or the like of an employee and a processing in combination with the secondary data is carried out. A client (CL) has a viewer detector (CLBD) and a display (CSOD), and the viewer detector (CLBD) detects that a user views the display by receiving infrared ray information including a user ID sent from the terminal (TR). As a method of detecting a viewer, other than an infrared ray sensor, a wireless transmitter receiver or RFID, face recognition by a camera or the like may be used. In a case where a viewer is detected, the client (CL) transmits a list of viewers to the application server (AS) and the application server (AS) returns content for the viewers to the client (CL). The client (CL) displays the received content on a screen (OD) of the display (CLOD), and emphasizes to display a portion with regard to the current viewer. Thereby, the current viewer can be made to notice predominantly information in which the viewer is strongly interested, or information which is intended to be interested by the viewer. Further, also a personal client (CP) can acquire content from the application server (AS) and display the content similar to the client (CL). At this occasion, as a client (CL) which does not have the viewer detector (CLBD), the personal client (CP) can be set with an ID of a specific user (US3) as an owner. In displaying, the user can be regarded to necessarily view the display, and the user can also be emphasized to display. Further, when input/output of a comment by the user (US) is needed, an electronic mail can also be transmitted or received by using the personal client (CP).

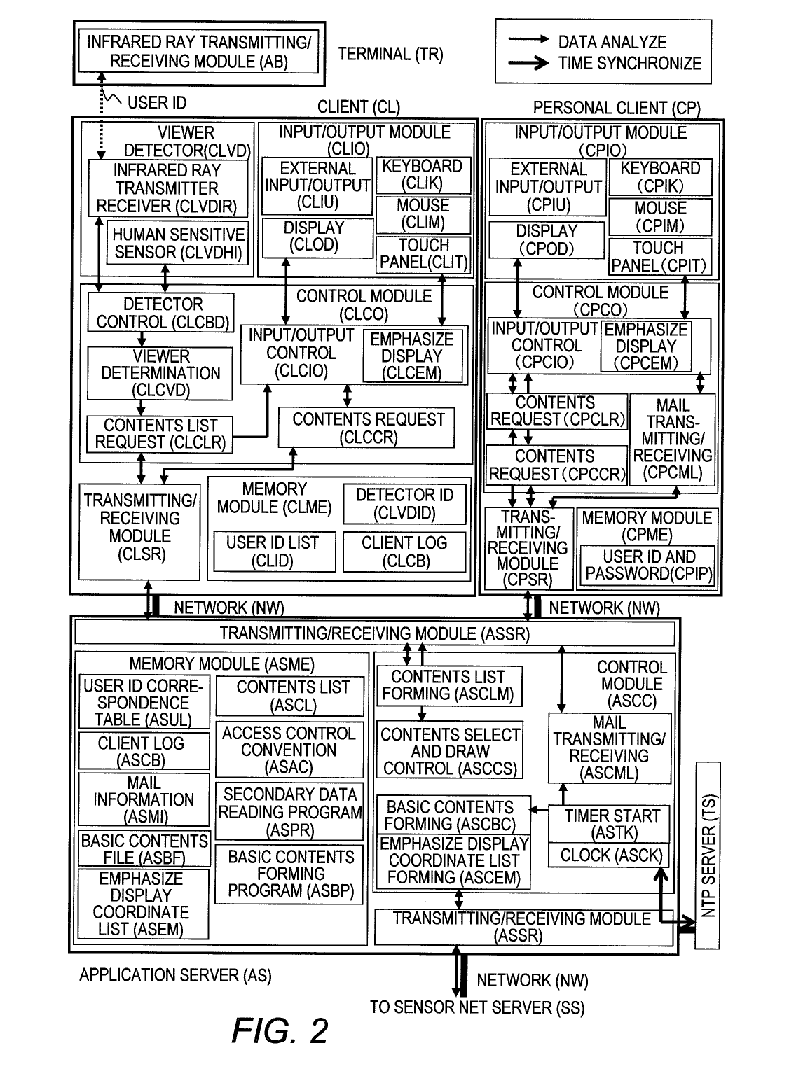

### <FIG. 2-FIG. 4: Block Diagrams of a Total System>

FIG. 2 to FIG. 4 are block diagrams for explaining a total configuration of a sensor network system for realizing the sensing data display apparatus of the embodiments of this invention. Although the block diagrams are dividedly shown for convenience of illustration, respective processings which are respectively illustrated are executed by being linked with each other. Further, respective functions in the diagrams are realized by hardware or software, or combinations of these, and function blocks are not necessarily accompanied by hardware entities. As is apparent from the diagrams 2 through 4, the respective constituent elements have control modules, memory modules, and transmitting/receiving modules. The control module is configured by a central processing unit: CPU (not illustrated) or the like which is a processing module of an ordinary computer or the like, the memory module is configured by a memory apparatus of a semiconductor memory apparatus, a magnetic memory apparatus or the like, and the transmitting/receiving module is configured by a wireless or wired network interface. Otherwise, a clock or the like is included as necessary.

By the terminal (TR), a sensing data with regard to a motion or a communication of a person who wears the terminal is acquired, and the sensing data is stored to the sensor net server (SS) by way of the base station (GW). Further, content formed at the application server (AS) are called from the client (CL) or the personal client (CP) and outputted to the display (CLOD or CPOD) of the client (CL or CP). The client (CL) always monitors a viewer, and changes a content of display by a method suitable for the viewer. FIG. 2 through FIG. 4 show a series of flows of these.

Five kinds of arrow marks having different shapes in FIG. 2 through FIG. 4 respectively represent flows of data or signals for synchronizing time, associating, storing acquired sensing data, analyzing sensing data, updating firmware, and a control signal.

### <FIG. 2: Total System 1 (CL, CP, and AS)>

FIG. 2 shows a configuration of an embodiment of the client (CL) and the personal client (CP) and the application server (AS).

### <With Regard to Client (CL)>

The client (CL) becomes a point of contact with a user (US) and inputs/outputs data. The client (CL) includes an input/output module (CLIO), a transmitting/receiving module (CLSR), a memory module (CLME), a control module (CLCO), and a viewer detector (CLVD).

The input/output module (CLIO) is a portion which becomes an interface with the user (US). The input/output module (CLIO) includes a display (CLOD), a touch panel (CLIT), a keyboard (CLIK), and a mouse (CLIM) and the like. Other input/output apparatus can also be connected to an external input/output (CLIU) as necessary.

The display (CLOD) is an image display apparatus of a CRT (Cathode-Ray Tube) or a liquid crystal display or the like. The display (CLOD) may include a printer or the like. In a case where the touch panel (CLIT) is used for assisting an input by a user, the touch panel (CLIT) can be installed to overlap the display (OD) of the display (CLOD) and an output and an input can also be shown to be executed on the same display.

The transmitting/receiving module (CLSR) transmits and receives data or instructions to and from the application server (AS) or an apparatus connected to other network. Specifically, the transmitting/receiving module (CLSR) transmits a request for a content list or content to the application server (AS), and receives content in correspondence with the request.

The memory module (CLME) is configured by an external recording apparatus such as a hard disk, a memory, or an SD card. The memory module (CLME) includes a detector ID (CLVD) which is an ID of a viewer detector under control of the client (CL), a user ID (CLID) showing a list of effective user ID's, and a client log (CLCB) which accumulates a log with regard to a record of a detected viewer and its time of detection as well as an event which occurs at the client and so on.

The viewer detector (CLVD) is a terminal which is built in the client (CL) or externally connected to the client (CL), which includes an infrared ray transmitter receiver (CLVDIR) or a sensor of a Human Sensitive Sensor (CLVDHI) or the like for detecting a viewer who views the display (CLOD) of the client (CL). In a case where the viewer detector (CLVD) is externally connected to the client (CL), the viewer detector (CLVD) is connected by USB or the like. In order to enlarge a detecting range, plural pieces of the viewer detectors (CLVD) can be connected. When the viewer detector (CLVD) is failed, only the viewer detector (CLVD) can be switched to other individual. In a case where a viewer is detected by an infrared ray, the viewer is detected by receiving a user ID which is periodically sent from an Infrared Ray transmitting/receiving module (AB) by the terminal (TR) of which the user (US) wears.

The control module (CLCO) includes a CPU (not illustrated) and executes processings of a control of communication, an input/output control (CLCIO) for inputting an input with regard to selection of content from the user (US) or the like, and outputting content to the user (US), a control of the viewer detector (CLCBD), a determination of a viewer (CLCVD) for pertinently determining a viewer from detected data, a request for a content list (CLCLR), a request for content (CLCCR) to the application server (AS) and the like.

The detector control (CLCBD) controls an operation of the viewer detector (CLVD). In the detector control (CLCBD), a detector ID (CLVDID) is provided and transmitted from the viewer detector (CLVD). It is confirmed by referring to the user ID List (CLID) that received information is not noise but effective data. A transmitting/receiving timing of an infrared ray is controlled at the viewer detector (CLVD). The detector control (CLCBD) may be carried out by the viewer detector (CLVD). However, in a case where the detector control (CLCBD) is carried out by the control module (CLCO) in the client (CL), even if the viewer detector (CLVD) is interchanged by other individual when the viewer detector (CLVD) is failed, the detector ID (CLVDID) and the operation of the detector stay the same. Therefore, it is an advantage that the other individual can be dealt with as the same individual without being conscious thereof.

In the viewer determination (CLCVD), the user who is regarded to be viewed at a current time point is specified successively based on a detected data which is obtained from the viewer detector (CLVD). For example, a user having an ID which has been detected only at a moment is regarded not to be viewed. Further, even when the user is viewed, transmission of an infrared ray from the terminal (TR) can be hampered by the arm or the like. Therefore, during 30 seconds after finally detecting the viewer, the viewer is regarded to be viewed even when the ID is not detected. These processing are carried out, and the user ID of the viewer is monitored always at the time point. In addition thereto, a determination that the viewed user leaves the front side of the display is also carried out.

In the content list request (CLCLR), the list of user ID's of current viewers is sent to the application server (AS), and the content list having a viewing authorization by the member configuration, and names of viewers are received from the application server (AS). The content list having the viewing authorization may be formed in the client (CL) by holding a content list (ASCL) and an access control convention (ASAC) in the client (CL). However, the security can be maintained without holding names of users which are personal information at the client (CL) by creating the content list having the viewing authorization (ASCLM) and searching the name from the user ID in the application server (AS).

The input/output control (CLCIO) generates and controls an image of a display which is outputted to the display (CLOD), and also receives an input from the touch panel (CLIT) or the mouse (CLIM) or the like. An output image is changed successively in accordance with the input, that is, the operation of the user. The input/output control (CLCIO) reflects the content list and names of users received from the application server (AS), and displays a content switch button (OD_C1) or a viewer select button (OC_A1) in the image. These buttons are for selecting content which the user intends to view, and only buttons which are related to content having the viewing authorization by the member configuration of the viewers at that occasion are displayed. By the mechanism, the viewer cannot make access to content without the viewing authorization, and therefore, a viewing restriction is realized.

The input/output control (CLCIO) waits for an input from the touch panel (CLIT) or the mouse (CLIM) or the like by the user operation, in the case of the input, transmits the request for the content in correspondence with the button to the application server (AS), and receives content information (CLCCR). The content information is mainly an image, and also an emphasize display coordinate list (ASEM) in correspondence with the user ID is received. In a case where there is not a designation by the user operation, a data of the newest date is requested. The input/output control (CLCIO) displays an image of content at the display, and an emphasize display (CLCEM) overlappingly displays a rectangular or circular sign thereon for emphasizing coordinates in correspondence with a current viewer. Further, in the emphasize display (CLCEM), the content image is displayed by moving or enlarging the image such that a portion including the current viewer comes to a center. By this mechanism, attention is paid first to information which has a high priority for the viewer at that time.

### <Personal Client (CP)>

The personal client (CP) has a function substantially the same as that of the client (CL). A specific individual uses a PC or the like which a specific individual possesses as the personal client (CP) for viewing data of the viewer per se. Therefore, the personal client (CP) may not have the viewer detector (CLVD), but instead, the personal client (CP) holds a user ID of a single person who is an owner and a password (CPIP) thereof at a memory module (CPME). Thereby, a viewer carries out a display similar to that of the client (CL) always on the premise of the specific single person.

Further, the personal client (CP) may have a mail transmitting/receiving (CPCML) function. The client (CL) may have a function of transmitting/receiving to and from a mail address of a viewer. The mail transmitting/receiving (CPCML) function can be utilized for receiving a result of processing sensing data of an individual, or transmitting a text message directed to all participants of a system, or a specific other person, or the individual per se.

Otherwise, all of functions of the personal client (CP) correspond to functions of the client (CL) and achieve respectively the same functions. An input/output module (CPIO) corresponds to the input/output module (CLIO), an external input/output (CPIU) corresponds to the external input/output (CLIU), a display (CPOD) corresponds to the display (CLOD), a keyboard (CPIK) corresponds to the keyboard (CLIK), a mouse (CPIM) corresponds to the mouse (CLIM), and a touch panel (CPIT) corresponds to the touch panel. A control module (CPCO) corresponds to the control module (CLCO), an input/output control module (CPCIO) corresponds to the input/output control (CLCIO), an emphasize display (CPCEM) corresponds to the emphasize display (CLCEM), a content list request (CPCLR) corresponds to the content list request (CLCLR), a content request (CPCCR) corresponds to the content request (CLCCR), a transmitting/receiving module (CPSR) corresponds to the transmitting/receiving module (CLSR), and the memory module (CPME) corresponds to the memory module (CLME).

### <Application Server (AS)>

The application server (AS) processes and analyzes secondary data of sensing data, and creates content information (frequently an image, however, other data of a time/varying image, a text data, a voice data or the like will do) for presenting to a user via the client (CL).

The application server (AS) includes a transmitting/receiving module (ASSR), a memory module (ASME), and a control module (ASCO).

The transmitting/receiving module (ASSR) transmits and receives data to and from the Sensor net server (SS), the business information control server (GS), the NTP server (TS), the client (CL), and the personal client (CP) via the network (NW) and executes a communication control therefor.

The memory module (ASME) is configured by an external recording apparatus such as a hard disk, a memory, or an SD card. The memory module (ASME) stores created content information, a program for creating content, as well as data related to forming content. Specifically, the memory module (ASME) stores a user attribute list (ASUL), the content list (ASCL), a client log (ASCB), the access control convention (ASAC), mail information (ASMI), a basic content file (ASBF), the emphasize display coordinate list (ASEM), a secondary data reading program (ASPR), and a basic content creating program (ASBP).

The user attribute list (ASUL) is a correspondence table of an ID of the terminal (TR), and a name and a user ID and a position in a department or a section, a mail address, an attribute or the like of a user (US) wearing the terminal. When a user ID of a detected viewer is received from the client (CL), a name of the corresponding user is referred to the user attribute list (ASCLM) and is returned to the client (CL). Further, the user attribute list is used for determining a member included in content for each position in an organization.

The client log (ASCB) is accumulated with a log (CLCB) of the client (CL) or the personal client (CP), and is recorded with an ID of a detected viewer and time of detection thereof, content of an operation, a kind of content viewed and the like. The client log (ASCB) can be utilized for predominantly displaying content which are frequently selected by the user (US).

The content list (ASCL) is a list describing a list of content which can be presented by the client (CL). In a case where the content list request (CLCLR) is received from the client (CL) along with a user ID of a viewer, both of the content list (ASCL) and the access control convention (ASAC) are referred to, and a list which can be viewed by a current viewer is extracted in the content list creation (ASCLM) and is returned to the client (CL).

The access control convention (ASAC) defines a viewable condition for individual content. The access control convention (ASAC) is mainly defined by a user ID. For example, the user ID is defined by OR of a logical equation such that content are viewable when a user belonging to a specific organization or a user at and above a specific position is included in viewers. Further, the user ID may be defined by AND of a logical equation such that content are viewable only when all of specific members are detected by the viewer detector. Further, the user ID may be defined such that content cannot be viewed exclusively when there is a specific member.

The mail information (ASMI) is a piece of information which records a format of content of a mail which is transmitted by mail transmitting/receiving (ASCML), a result of extracting a text message returned from the user (US), or time of transmitting/receiving.

The basic content file (ASBF) is content information (frequently an image, however, a time-varying image or a text data, a voice data or the like will do) which is outputted as a result of basic content creation (ASCBC). The basic content file (ASBF) may be an image based on sensor data with regard to a specific member during a specific period of time, or may hold content of a text, a coordinate value or the like as text data and may be formed into an image by combining and rearranging a basic content file when called by the client (CL). The basic content file (ASBF) may be a program which changes a shape of an image in real time in accordance with an operation of a user as in Servlet. All of the content are attached with tags of a date, a user ID or a system ID, a content kind and the like, and the tags are specified to one by a request from the client (CL).

The emphasize display coordinate list (ASEM) is a list which describes a coordinate in correspondence with the user ID to the image of the basic content file (ASBF). Thereby, when a viewer is detected, a coordinate in correspondence with the viewer is emphasized by surrounding the coordinate by a rectangle or a circle. Further, an emphasizing method, for example, a shape or a color, a boldness, a kind of a line or the like of a sign to be emphasized can also be designated. Further, additional information which is displayed at a side of an emphasizing sign, for example, a name of a user, or a text showing reason of emphasizing or the like can also be designated. Even in a case where the basic content file (ASBF) is not an image, by designating a portion of data which corresponds to a specific user or a member of an organization to which the member belongs by the emphasize display coordinate list (ASEM), the basic content file (ASBF) may be added with emphasizing information and outputted by the client (CL).

The secondary data program (ASPR) is a program for reading secondary data of sensing data received from the sensor net server (SS). The secondary data reading program (ASPR) holds a format of a file of a meeting matrix (ASMM), a motion rhythm tapestry (SSDB_ACCTP) or the like which is a secondary data, and reads data of designated date and time and object user in line with the format.

The basic content creating program (ASBP) is configured by various programs for creating basic content. In the basic content creation (ASCBC), the basic content creation (ASCBC) is started by timer start (ASTK) or manually started by a controller, or started by receiving a request by the client (CL), and outputs the basic content file.

The control module (ASCO) includes a CPU (not illustrated) and executes a control of transmitting/receiving data and a processing of data. Specifically, by executing a program stored to the memory module (ASME) by the CPU (not illustrated), processings of the content list creation (ASCLM), a content select and draw control (ASCCS), the mail transmitting/receiving (ASCML), the timer start (ASTK), the basic content creation (ASCBC), and an emphasize display coordinate list creation (ASCEM) and the like are executed. Further, a clock (ASCK) held at inside holds standard time of the actual place by being periodically connected to an NTP Server (TS).

The content list creation (ASCLM) is a processing which refers to both of the content list (ASCL) and the access control convention (ASAC), extracts a list of content having an authorization of viewing to a viewer of the current client (CL), and returns the list to the client (CL) in a case where the content list request (CLCLR) is received from the client (CL) along with the user ID of the viewer.

The content select and draw control (ASCCS) is a processing which outputs designated content from the basic content file (ASBF) by selection of the user (US) who views the display (CLOD) of the client (CL), or an automatic request of the client (CL), and returns the designated content to the client (CL) along with the emphasize display coordinate list (ASEM) in correspondence therewith as necessary. Further, in a case of content which is moved interactively in accordance with an operation of the user (US) as in Servlet, drawing thereof is controlled at the content select and draw control (ASCCS). Further, a processing of creating one sheet of an image is carried out by being combined with the basic content file in accordance with a member configuration of the viewing user (US).

In the timer start (ASTK), a processing of the basic content creation (ASCBC) or the mail transmitting/receiving (ASCML) is started when the clock (ASCK) becomes previously designated time.

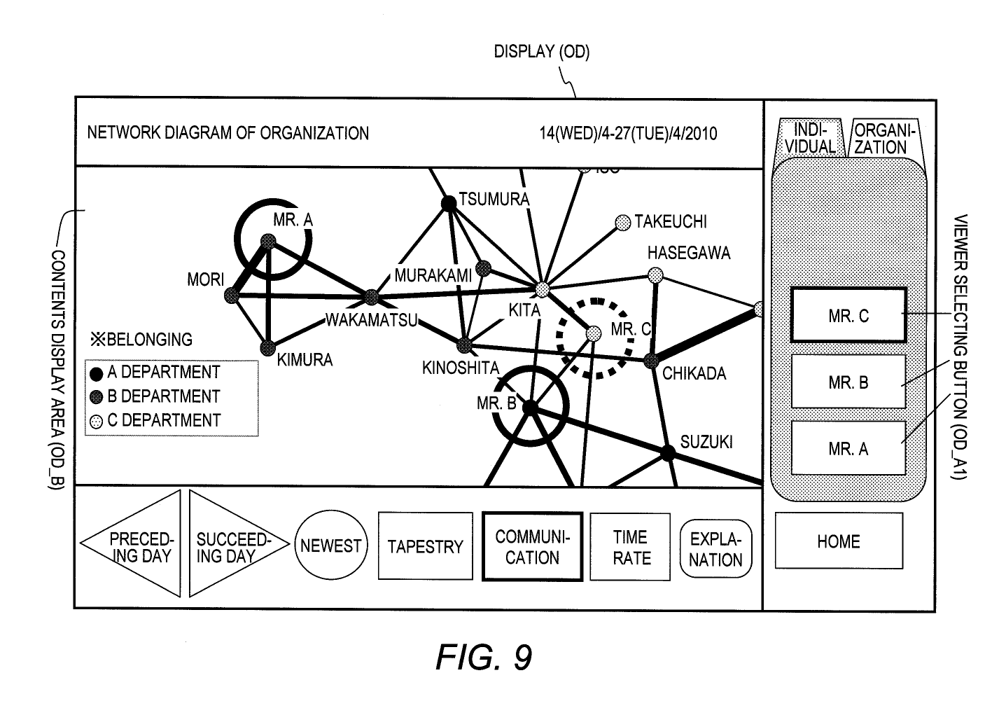

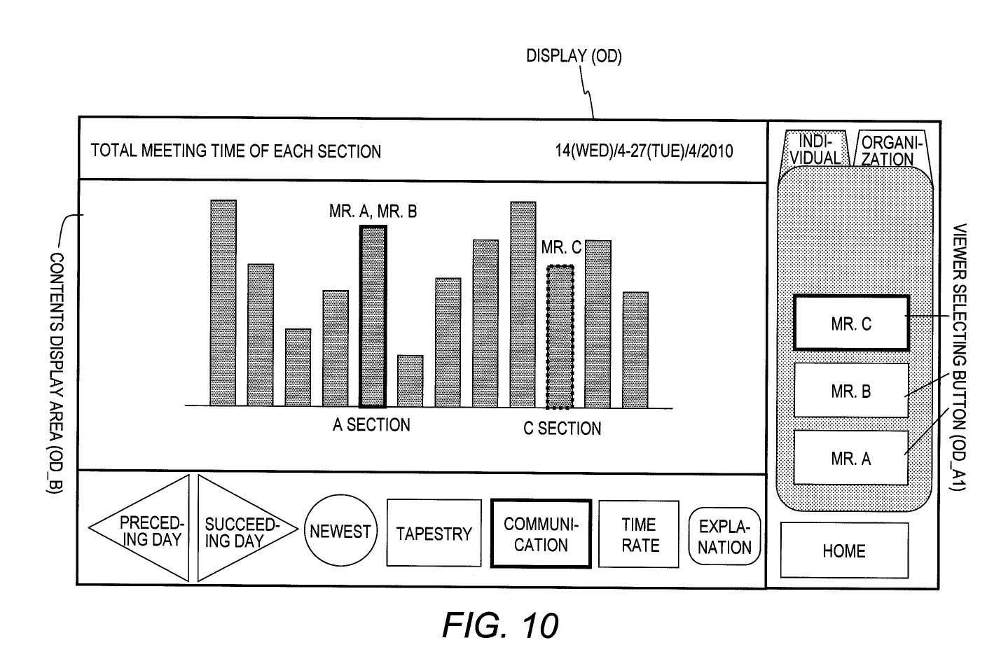

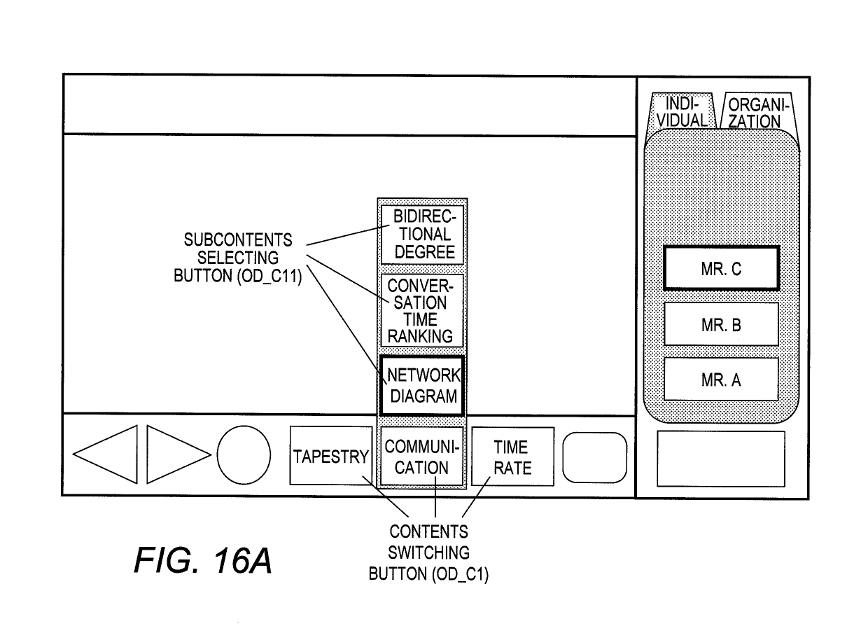

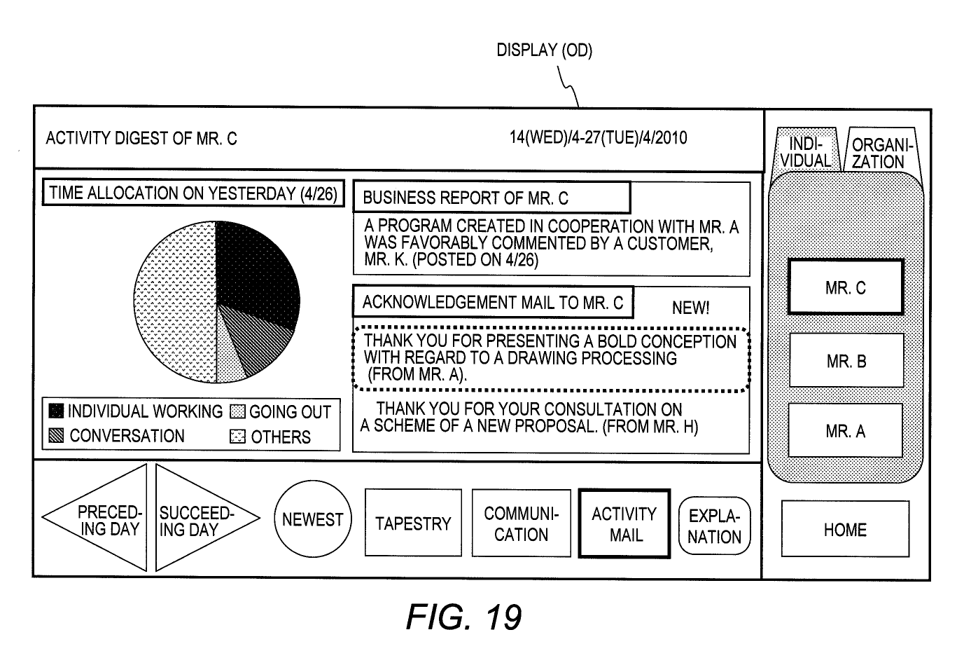

The basic content creation (ASCBC) reads the basic content creating program (ASBP), processes sensing data acquired from the sensor net server (SS) or secondary data thereof, and outputs the Basic content file (ASBF). Specifically, the basic content creation (ASCBC) outputs the basic content file (ASBF) of a network diagram (FIG. 9) or a graph (FIG. 10) of an index of each system, a circular graph (FIG. 15) of a rate of how to use time of an individual, an activity digest (FIG. 19) including a business report which is inputted by the user (US) by a mail and the like.

In the basic content creation (ASCBC), the emphasize display coordinate list is outputted (ASCEM) as necessary. The basic content creation (ASCBC) is a processing of storing the user ID, a sign in correspondence with the user, and a coordinate value of drawing a graph and outputting a user ID and a coordinate value as a list in the basic content creating processing.

The mail transmitting/receiving (ASCML) transmits a data analyzing result or items of the questionnaire for a specific user to the personal client (CP) by a mail. Further, the mail transmitting/receiving (ASCML) receives a mail which is received from the personal client (CP), extracts only information necessary for forming content from content thereof and preserves the information at the mail information (ASMI).

In this way, by dividing the client (CL) and the application server (AS), personal information or secret information may not be preserved in the client (CL), and therefore, the client can be placed outside of a security area. However, by integrating the client (CL) and the application server (AS), the content file or the user attribute list may be held in the client.

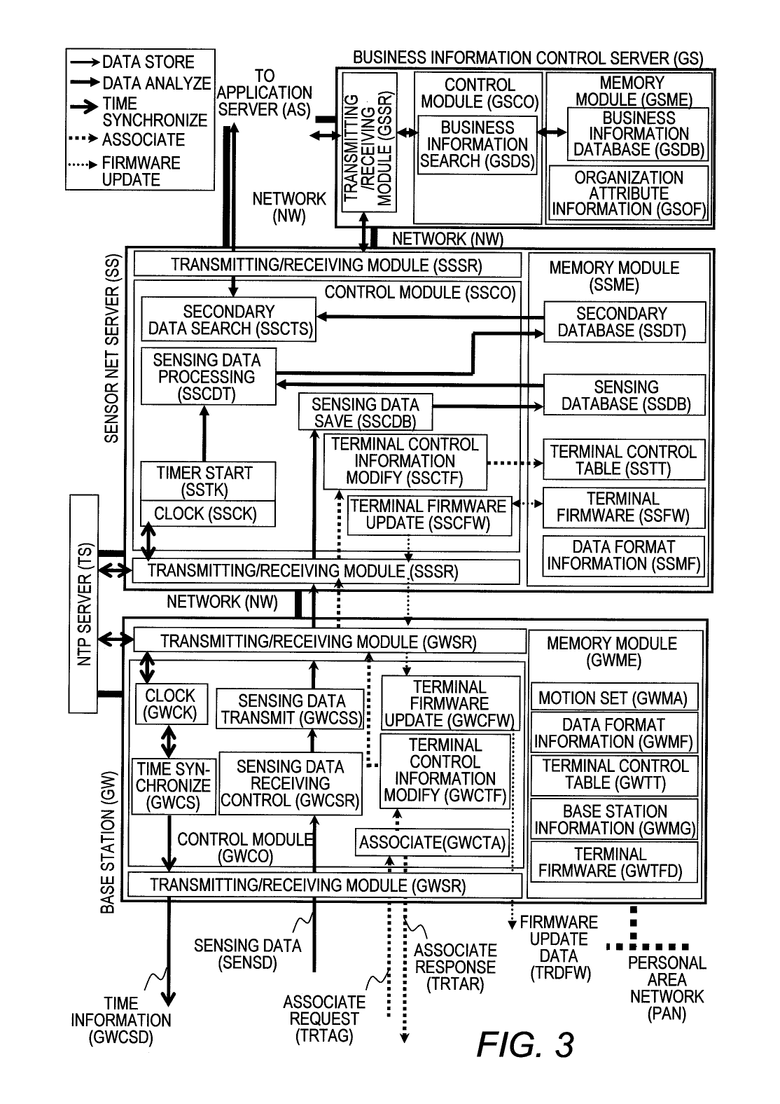

### <FIG. 3: Total System 2 (SS, GW, and IS)>

FIG. 3 shows a configuration of an embodiment of the sensor net server (SS), the business information control server (GS), and the base station (GW).

### <Sensor Net Server (SS)>

The sensor net server (SS) controls data which are collected from all of the terminals (TR). Specifically, the sensor net server (SS) stores a sensing data which is transmitted from the base station (GW) at a sensing database (SSDB), and transmits sensing data or secondary data based on a request from the application server (AS) or the client (CL). Further, the sensor net server (SS) controls information of the base station (GW) and the terminal (TR) under control thereof at any time. Further, the sensor net server (SS) becomes an onset of a control command for updating a firmware of the terminal (TR). Further, in a case of analyzing both of business information and sensing data or creating content, the sensor net server (SS) is connected with the business information control server (GS) by the network (NW), and carries out an analyzing processing in combination with the business information.

The sensor net server (SS) includes a transmitting/receiving module (SSSR), a memory module (SSME), and a control module (SSCO).

The transmitting/receiving module (SSSR) transmits and receives data to and from the base station (GW), the application server (AS), the business information control server (GS), the personal client (CP), and the client (CL), and carries out a communication control at that occasion.

The memory module (SSME) is configured by a data storing apparatus of a hard disk or the like, and stores at least the sensing database (SSDB), a secondary database (SSDT), a data format information (SSMF), a terminal control table (SSTT), and a terminal firmware (SSTFD). Further, the memory module (SSME) stores a program which is executed by a CPU (not illustrated) of the control module (SSCO).

The sensing database (SSDB) is a database for recording sensing data acquired by the respective terminals (TR), information of the terminal (TR), and information of the base station (GW) through which the sensing data transmitted from the respective terminals (TR) pass and the like. Columns are created for respective elements of data of an acceleration, a temperature and the like, and the data are controlled. Further, tables may be formed for respective elements of data. In any of the cases, all of data are controlled by relating terminal Information (TRMT) which is an ID of the acquired terminal (TR) and information with regard to sensed time.

The secondary database (SSDT) is a database for storing a result of subjecting data of the sensing database (SSDT) to a sensing data processing (SSCDT). Secondary data which are stored to the secondary database (SSDT) are standardized data processed by preparation, noise is removed therefrom, and stored in a format which is suitable for creating basic content, for example, a format of outputting a total meeting time between arbitrary two users (US) in a matrix format, for example, for each day. In the basic content creation (ASCBC) at the application server (AS), a content forming program can be developed without considering a characteristic of the sensing data which depend on the terminal (TR) or a communication situation of removing noise or the like by unifying to acquire the secondary data. As the database, the secondary database (SSDB) which is common to the sensing database (SSDT) is used, and only tables may be divided. Further, the basic content creation (ASCBC) may acquire data before the sensing data processing (SSCDT) from the sensing database (SSDB).

The data format information (SSMF) is recorded with information or the like of a data format of communication, a method of cutting to divide tagged sensing data and recording the data to a database at the base station (GW), a method of recording secondary data subjected to the sensing data processing (SSCDT) to the secondary database (SSDT), and a method of dealing with a request of data. After receiving data and before transmitting data, the data format information (SSMF) is referred to, and conversion of data format and distribution of data are carried out.

The terminal control table (SSTT) is a table of recording which terminal (TR) is currently under control of which base station (GW). When the terminal (TR) is newly added under control of the base station (GW), the terminal control table (SSTT) is updated. Further, in a case where the base station (GW) and the terminal (TR) are connected by wire, the terminal control information may not be monitored always.

The terminal firmware (SSFW) stores a program for operating the terminal, and when terminal firmware updating (SSCFW) is carried out, the terminal firmware (SSFW) is updated, the updated firmware is transmitted to the base station (GW) via the network (NW), further transmitted to the terminal (TR) via the personal area network (PAN), and updates the firmware in the terminal (TR) (FMUD).

The control module (SSCO) includes a CPU (not illustrated), and controls transmission/reception of sending data and recording and outputting the sending data to and from a database. Specifically, by executing programs stored to the memory module (SSME), processings of sending data save (SSCDB), terminal control information modify (SSTF), terminal firmware update (SSCFW), sensing data processing (SSCDT), and secondary data search (SSCTS) and the like are executed.

The sensing data save (SSCDB) is a processing of receiving the sensing data transmitted from the base station (GW) and storing the sensing data to the sensing database (SSDB). Time information, the terminal ID and additional information of time of passing by way of the base station and the like are put together to be 1 record and stored to the database.

A clock (SSCK) maintains standard time by being connected periodically to an external NTP Server (TS). The sensing data processing (SSCDT) is subjected to timer start (SSTK) at time which is previously designated by the clock (SSCK), or when a specific condition is satisfied.

The sensing data processing (SSCDT) subjects the sensing data from the sensing database (SSDB), or what is acquired at the terminal (TR) to preparation by a method designated by the data format information (SSMF) to thereby create secondary data. The secondary data is stored to the secondary database (SSDT). The secondary database is maintained to be brought into an always updated state by starting the sensing data processing (SSCDT) at constant intervals and processing sensing data which are newly added.

The secondary data search (SSCTS) carries out a processing in which when a request is received from the application server (AS) or the business information control server (GS), secondary data in correspondence with the request is outputted from the secondary database (SSDT) and returned to a source of the request. At that occasion, a search is carried out based on tag information of date, user ID or the like attached to the secondary data.

The terminal control information modify (SSTF) updates the terminal control table (SSTT) when a command of modifying terminal control information is received from the base station (GW). The terminal control information modify (SSTF) is for always grasping a list of the terminals (TR) under control of respective base stations (GW).

When it is necessary to update the firmware of the terminal (TR) manually or automatically, the terminal firmware update (SSCFW) updates the terminal firmware (SSFW) in the memory module (SSME), and issues an instruction to the base station (GW) so as to update the firmware of the terminal (TR) under control of the base station (GW). The terminal firmware update (SSCFW) receives responses that each firmware has been finished updating at the respective terminals (TR), and continues updating until all of the terminals (TR) have been finished updating.

### <Business Information Control Server (GS)>

The business information control server (GS) is a server accumulating information by which a system controls employees or business progress. A memory module (GSME) thereof includes an Organization Attribute Information (GSOF) of a department to which an employee belongs and a position thereof, age, gender and the like of the employee. Further, the memory module (GSME) includes a business information database (GSDB) of information with regard to a result, a progress, accounting of a business, for example, sale and expenditure, a degree of achieving a result for a scheme of each department.

A control module (GSCO) of the business information control server (GS) includes a business information search (GSDS) and provides business information data or the organization attribute information (GSOF) in the memory module (GSME) by receiving a request from the application server (AS) or the sensor net server (SS). At this occasion, data is transmitted to a source of the request via a transmitting/receiving module (GSSR) after checking whether the source of the request has an authority of capable of making an access to the information, or, in a case where a format of information in the memory module (GSME) is unified, or putting the format into order.

### <Base Station (GW)>

The base station (GW) has a role of intermediating the terminal (TR) and the sensor net server (SS). In a case of connecting the terminal (TR) and the base station (GW) by wireless, the plural base stations (GW) are arranged such that regions of living quarters, the offices or the like are covered in consideration of an arrival distance of wireless. In a case of connecting the base station (GW) and the terminal (TR) by wire, an upper limit of a number of pieces of controlled terminals (TR) is set in accordance with a processing capability of the base station (GW).

The base station (GW) includes a transmitting/receiving module (GWSR), a memory module (GWME), and a control module (GWCO).

The transmitting/receiving module (GWSR) receives data from the terminal (TR) by wireless or wire, and carries out transmission to the sensor net server by wire or wireless. In a case where wireless is used in transmission/reception, the transmitting/receiving module (GWSR) includes an antenna for receiving wireless. Further, the transmitting/receiving module (GWSR) carries out a congestion control, that is, a control of a timing of communication such that data is not deficient in transmitting/receiving sensing data as necessary. Further, the transmitting/receiving module (GWSR) distinguishes a kind of received data. Specifically, the transmitting/receiving module (GWSR) discerns whether the received data is general sensing data, or data for an associate, or a response of time synchronization or the like from a header portion of data, and conveys the data respectively to pertinent functions.

The memory module (GWME) is configured by an external recording apparatus (not illustrated) such as a hard disk, a memory, or an SD card. The memory module (GWME) is stored with an operation set (GWMA), a data format information (GWMF), a terminal control table (GWTT), a base station information (GWMG), and a terminal firmware (GWTFD). The operation set (GWMA) includes information indicating a method of operating the base station (GW). The data format information (GWMF) includes information showing a data format for communication, and information necessary for attaching a tag to sensing data. The terminal control table (GWTT) includes the terminal information (TRMT) of the terminal (TR) under control which can be associated with currently, and local ID's which are distributed for controlling the terminals (TR). In a case where the memory module (GWMA) is connected to the terminal (TR) by wire, and it is not necessary to always grasp the terminal (TR) under control, the terminal control table (GWTT) is dispensed with. The base station information (GWMG) includes information of an address or the like of the base station (GW) per se. The terminal firmware (GWTFD) stores a program for operating the terminal. When an instruction and a new terminal firmware are received from the sensor net server (SS), the terminal firmware (GWTFD) transmits a firmware update data (TRDFW) to the terminal (TR) via the personal area network (PAN) (GWCFW).

The memory module (GWME) may further be stored with a program which is executed by a CPU (not illustrated) of the control module (GWCO).

The control module (GWCO) includes a CPU (not illustrated). By executing programs stored to the memory module (GWME) by the CPU, a timing of receiving sensing data from the terminal (TR), a processing of the sensing data, a timing of transmission/reception to and from the terminal (TR) or the sensor net server (SS), and a timing of time synchronization are controlled. Specifically, the control module (GWCO) executes processings of a sensing data receiving control (GWCSR), a sensing data transmit (GWCSS), an associate (GWCTA), a terminal control information modify (GWCTF), the terminal firmware update (GWCFW), and time synchronize (GWCS) and the like.

A clock (GWCK) holds time information. The time information is updated at constant intervals. Specifically, time information of the clock (GWCK) is modified by time information acquired from the NTP (network time protocol) server (TS) at constant intervals.

The time synchronize (GWCS) transmits time information to the terminal (TR) under control at constant intervals, or connection of the terminal (TR) to the base station (GW) as a trigger. Thereby, times of the plural terminals (TR) and the clock (GWCK) of the base station (GW) are synchronized.

The associate (GWCTA) carries out an associate response (TRTAR) of transmitting assigned local ID's to the respective terminals (TR) in response to associate request (TRTAQ) transmitted from the terminal (TR). When associate is established, the associate (GWCTA) carries out the terminal control information modify (GWCTF) of modifying the terminal control table (GWTT).

The Sensing data receiving control (GWCSR) receives a packet of sensing data (SENSD) transmitted from the terminal (TR). The sensing data receiving control (GWCSR) reads a header of the packet of the data, determines a kind of the data, and carries out a congestion control such that data from a number of the terminals (TR) do not concentrate simultaneously.

The sensing data transmit (GWCSS) provides an ID of a base station through which data are passed and time data thereof and transmits sensing data to the sensor net server (SS).

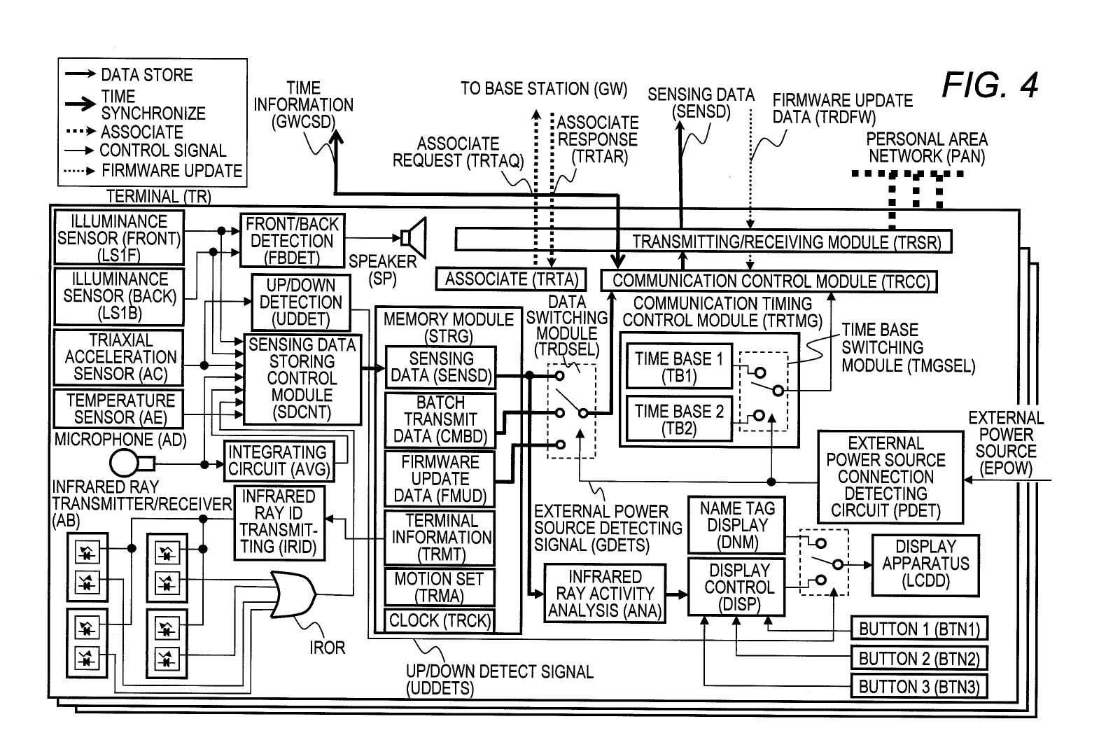

### <FIG. 4: Total System 3 (TR)>

FIG. 4 shows a configuration of the terminal (TR) which is an embodiment of a sensor node. Although here, the terminal (TR) is formed in a shape of a name tag, and is assumed to hang from the neck of a person, this is an example, and the terminal (TR) may be formed by other shape. In a number of cases, there are plural terminals (TR) in a series of systems, and persons belonging to organizations respectively wear the terminals (TR). The terminal (TR) has plural Infrared Ray transmitting/receiving modules (AB) for detecting a meeting situation of a human, a triaxial acceleration sensor (AC) for detecting a motion of a wearer, a microphone (AD) for detecting speech of a wearer and surrounding sound, and various sensors of illuminance sensors (LS1F, LS1B) for detecting front/rear of the terminal, and a temperature sensor (AE). The installed sensor is an example, and other sensor may be used for detecting the meeting situation and the motion of the wearer.

According to the embodiment, four sets of the infrared ray transmitting/receiving modules are installed. The Infrared Ray transmitting/receiving module (AB) continues transmitting periodically terminal information (TRMT) which is inherent identifying information of the terminal (TR) in a front direction. In a case where a person wears other terminal (TR) is disposed substantially on a front side (e.g. front side or skewed front side), the terminal (TR) and the other terminal (TR) exchange respective terminal information (TRMT) to each other by infrared rays. Therefore, it can be recorded who meets whom. Further, the viewer detector (CLVD) can detect which user (US) views the display (CLOD) of the client (CL) by receiving the terminal information (TRMT). Further, conversely, it can be recorded that the user (US) stays at a location of installing the client (CL) by receiving the detector ID (CLVDID) transmitted from the viewer detector (CLVD) by the terminal (TR).

Each infrared ray transmitting/receiving module is generally configured by a combination of an infrared ray emitting diode and an infrared ray phototransistor for transmitting an infrared ray. An infrared ray ID transmitting module (IrID) forms terminal information (TRMT) which is an ID of its own and transmits the terminal information (TRMT) to an infrared ray emitting diode of an infrared ray transmitting/receiving module. According to the embodiment, by transmitting the same data to the plural infrared ray transmitting/receiving modules, all of the infrared ray emitting diodes are simultaneously lighted. Naturally, respectively independent timings or different data may be outputted.

Further, a logical sum is calculated by a logical sum circuit (IROR) for data received by the infrared ray phototransistors of the infrared ray transmitting/receiving modules (AB). That is, when the ID is received by at least any one of the infrared ray receiving modules, the ID is recognized by the terminal. Naturally, a configuration having plural circuits of receiving ID independently from each other will do. In this case, transmitting/receiving states can be grasped for respective infrared ray transmitting/receiving modules, and therefore, additional information of in which direction a meeting other terminal is disposed can also be obtained.

sensing data (SENSD) detected by the sensor is stored to a memory module (STRG) by a sensing data store control module (SDCNT). The sensing data (SENSD) is processed into a transmission packet by a communication control module (TRCC) and is transmitted to the base station (GW) by a transmitting/receiving module (TRSR).

At this occasion, it is a communication timing control module (TRTMG) that outputs the sensing data (SENSD) from the memory module (STRG) and determines a timing of transmission by wire. The communication timing control module (TRTMG) has plural time bases for determining plural timings.

As data stored to the memory module, other than the sensing data (SENSD) which is detected by the sensor immediately therebefore, there are a batch transmission data (CMBD) which has been accumulated in the past, and a firmware update data (FMUD) for updating a firmware which is an operation program of the terminal.

The terminal (TR) of the embodiment creates an external power source detecting signal (PDETS) by detecting that an external power source (EPOW) is connected by an external power source connection detecting circuit (PDET). A time base switching module (TMGSEL) for switching a transmission timing which is created by the communication timing control module (TRTMG) by the external power source detecting signal (PDETS), or a data switching module (TRDSEL) of switching data which is subjected to wireless communication are configurations particular to the terminal (TR). FIG. 4 illustrates, as an example, a configuration in which the time base switching module (TMGSEL) switches two time bases of a time base 1 (TB1) and a time base 2 (TB2) by the external power source detecting signal (PDETS) in transmission timings. Further, FIG. 4 illustrates a configuration in which the data switching module (TRDSEL) switches data to be communicated from the sensing data (SENSD) provided from the sensors, the batch transmission data (CMBD) accumulated in the past, and the firmware update data (FMUD) by the external power source detecting signal (PDETS).

The illuminance sensors (LS1F, LS1B) are respectively installed on a front face and a back face of the terminal (TR). Data acquired by the illuminance sensors (LS1F, LS1B) are stored to the memory module (STRG) by the sensing data storing control module (SDCNT), and at the same time, compared by a front/back detection module (FBDET). When the name tag is correctly set, the illuminance sensor (LS1F) installed to the front face receives externally coming light, and the illuminance sensor (LS1B) installed to the back face does not receive the externally coming light since the illuminance sensor (LS1B) is brought into a positional relationship of being squeezed between a main body of the terminal and the wearer. At this occasion, an illuminance detected by the illuminance sensor (LS1F) obtains a value larger than an illuminance detected by the illuminance sensor (LS1B). On the other hand, in a case where the front side and the back side of the terminal (TR) are reversed, the illuminance sensor (LS1B) receives the external arriving light, the illuminance sensor (LS1F) is directed to a side of the wearer, and therefore, the illuminance detected by the illuminance sensor (LS1B) becomes larger than the illuminance detected by the illuminance sensor (LS1F).

Here, by comparing the illuminance detected by the illuminance sensor (LS1F) and the illuminance detected by the illuminance sensor (LS1B) by the front/back detection portion (FBDET), it can be detected that the front side and the back side of the name tag node are reversed and the name tag node is not correctly worn. When it is detected that the front side and the back side are reversed by the front/back detection module (FBDET), an alarm sound is emitted by a speaker (SP) and the reversal is noticed to the wearer.

The microphone (AD) acquires voice information. By the voice information, a surrounding environment of “noisy”, or “quiet” or the like can be known. Further, by acquiring and analyzing voices of persons, meeting communication can be analyzed such that whether the communication is active or stagnant, whether the conversation is exchanged mutually equally, or is spoken one-sidedly, whether persons get angry or laugh and so on. Further, a meeting state which cannot be detected by the infrared ray transmitter receiver (AB) in view of a standing position of a person or the like can also be supplemented by voice information and acceleration information.

As voice acquired by the microphone (AD), both of a voice waveform, and a signal integrating the voice waveform by an integrating circuit (AVG) are acquired. The integrated signal represents the energy of the acquired voice.

The triaxial acceleration sensor (AC) detects an acceleration of the node, that is, a motion of the node. Therefore, from the acceleration data, an intensity of a motion of a person wears the terminal (TR), or a motion of walking or the like can be analyzed. Further, by comparing values of accelerations detected by plural terminals, a degree of activity, a mutual rhythm, a mutual correlation or the like of a communication between persons wears the terminals can be analyzed.

According to the terminal (TR) of the embodiment, data acquired by the triaxial acceleration sensor (AC) is stored to the memory module (STRG) by the sensing data store control module (SDCNT), and at the same time, a direction of a name tag is detected by an up/down detecting circuit (UDDET). The detection utilizes the fact that the acceleration detected by the triaxial acceleration sensor (AC), two kinds of a dynamic change in an acceleration by the motion of the wearer, and a static acceleration by the gravitation acceleration of the globe are observed.

When the terminal (TR) is set on the breast, the display apparatus (LCDD) displays personal information of a department or a section to which the wearer belongs, the name and the like. That is, the display apparatus (LCDD) behaves as a name tag. On the other hand, when the wearer carries the terminal (TR) by the hand, and directs the display apparatus (LCDD) to the wearer per se, up/down of the terminal (TR) is reversed. At this occasion, by an up/down detect signal (UDDETS) generated by the up/down detecting circuit (UDDET), a content displayed on the display apparatus (LCDD) and a function of a button are switched. According to the embodiment, there is shown an example in which by a value of the up/down detect signal (UDDETS), information displayed on the display apparatus (LCDD) is switched to a result of analysis by an Infrared ray activity analysis (ANA) generated by a display control (DISP) and a name tag display (DNM).

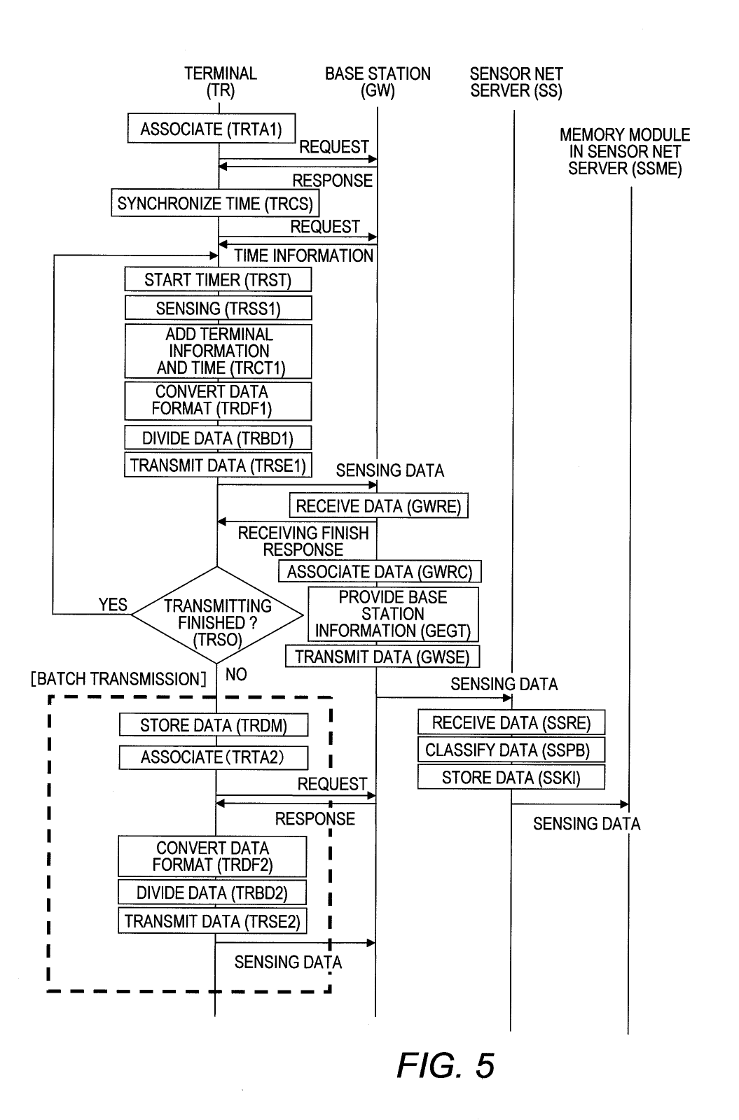

By exchanging infrared rays between the nodes by the Infrared Ray transmitting/receiving module (AB), it is detected whether the terminal (TR) faces other terminal (TR), that is, whether a person wearing the terminal (TR) meets a person wearing other terminal (TR). Therefore, it is preferable that the terminal (TR) is set to a front face portion of a person. As described above, the terminal (TR) further includes sensors of the triaxial acceleration sensor (AC) and the like. A process of sensing at the terminal (TR) corresponds to sensing (TRSS1) in FIG. 5.

In many cases, there are present the plural terminals. In a case where the terminal and the base station are connected by wireless, the respective terminals are connected to proximate base stations (GW) and creates the personal area network (PAN).

The temperature sensor (AE) of the terminal (TR) acquires a temperature at a location where the terminal is present, and the illuminance sensor (LS1F) acquires the illuminance in a front face direction of the terminal (TR). Thereby, a surrounding environment can be recorded. For example, based on the temperature and the illuminance, it can also be known that the terminal (TR) is moved from a certain location to other location based on the temperature and the illuminance.

As input/output apparatus in correspondence with a wearing person, there are provided Buttons 1 through 3 (BTN1 through 3), the display apparatus (LCDD), the speaker (SP) and the like.

The memory module (STRG) is specifically configured by a nonvolatile memory apparatus of a hard disk, a flash memory or the like and is recorded with terminal information (TRMT) which is an inherent identifying number of the terminal (TR), an interval of sensing, and a motion set (TRMA) of a content outputted to the display. Otherwise, the memory module (STRG) can record data temporarily, and is utilized for recording sensed data.

A clock (TRCK) is a clock which holds time information (GWCSD), and updates the time information (GWCSD) at constant intervals. The time information periodically corrects time by the time information (GWCSD) transmitted from the base station (GW) in order to prevent the time information (GWCSD) from being shifted from that of other terminal (TR).

The sensing data store control module (SDCNT) controls acquired data by controlling sensing intervals or the like of respective sensors in accordance with the motion set (TRMA) recorded at the memory module (STRG).

Time synchronization corrects a clock by acquiring time information from the base station (GW). The time synchronization may be executed immediately after associate described later, or may be executed in accordance with a time synchronize command transmitted from the base station (GW).

The communication control module (TRCC) executes a control of transmission intervals, and conversion to a data format in correspondence with wireless transmission/reception when data is transmitted/received. The communication control module (TRCC) may have a communication function not by wireless but by wire when needed. The communication control module (TRCC) may carry out a digestion control such that transmission timings of the terminal (TR) and other terminal (TR) do not overlap.

An associate (TRTA) determines the base station (GW) to which data is to be transmitted by transmitting and receiving an associate request (TRTAQ) and an associate response (TRTAR) for creating the personal area network (PAN) to and from the base station (GW). The associate (TRTA) is executed when a power source is inputted to the terminal (TR), and transmission/reception to and from the base station (GW) is cut up to that time as a result of moving the terminal (TR). In a case of wire connection, the associate (TRTA) is executed when it is detected that the terminal (TR) is connected to the base station (GW) by wire. As a result of the associate (TRTA), the terminal (TR) is related to one base station (GW) which is disposed within a proximate range which a wireless signal of the terminal (TR) reaches.

The transmitting/receiving module (TRSR) includes an antenna and carries out transmission and reception of a wireless signal. When needed, the transmitting/receiving module (TRSR) can also carry out transmission/reception by using a connector for a wire communication. data (TRSRD) transmitted and received by the transmitting/receiving module (TRSR) is transferred to and from the base station (GW) via the personal area network (PAN).

### <FIG. 5: Sequence of Storing Data>

FIG. 5 is a sequence diagram showing a procedure of storing sensing data, which is executed in an embodiment of this invention.

First, when a power source of the terminal (TR) is inputted, and the terminal (TR) is not brought into an associate state with the base station (GW), the terminal (TR) executes associate (TRTA1). associate defines that it is defined that the terminal (TR) is brought into a relationship of communicating with a certain base station (GW). By determining a transmission destination of data by associate, the terminal (TR) can firmly transmit data.

In a case where an associate response is received from the base station (GW) and the associate is succeeded, the terminal (TR) successively synchronizes time (TRCS). In synchronizing time (TRCS), the terminal (TR) receives time information from the base station (GW) and sets the clock (TRCK) in the terminal (TR). The base station (GW) is periodically connected to the NTP server (TS) and corrects time. Therefore, time is synchronized at all of the terminals (TR). Thereby, in carrying out an analysis later by verifying time information accompanied by sensing data, there can also be analyzed a mutual physical expression or an exchange of voice information in a communication between persons at the same time.

Timers are started by various sensors of the triaxial acceleration sensor (AC), the temperature sensor (AE) and the like of the terminal (TR) (TRST) at a constant period of, for example, at every 10 seconds, and there are sensed acceleration, voice, temperature, and illuminance and the like (TRSS1). The terminal (TR) detects a meeting state by transmitting/receiving a terminal ID which is one of terminal information (TRMT) to and from other terminal (TR) by an infrared ray. The various sensors of the terminal (TR) may always execute sensing without starting timers (TRST). However, the power source can efficiently be used by starting timers at a constant period, and the terminals (TR) can continuously be used for a long period of time without charging the terminal (TR).

The terminal (TR) adds time information of the clock (TRCK) and terminal information (TRMT) to sensed data (TRCT1). When data are analyzed, a person who wears the terminal (TR) is identified by the terminal information (TRMT).

In the data format conversion (TRDF1), the terminal (TR) provides tag information of a condition of sensing or the like to sensing data and converts sensing data into a determined wireless transmission format. The format is stored commonly in the data format information (GWMF) in the base station (GW) and the data format information (SSMF) in the sensor net server (SS). The converted data is thereafter transmitted to the base station (GW).

In a case where a large amount of continuous data of acceleration data and voice data and the like are transmitted, the terminal (TR) restricts much data which are transmitted simultaneously by dividing data (TRBD1) to be divided into plural packets. As a result thereof, a risk of a deficiency in data in a transmission procedure is reduced.

In transmitting data (TRSE1), data is transmitted to the base station (GW) which is an associate destination via the transmitting/receiving module (TRSR) in compliance with wireless protocol.

When the base station (GW) receives data (GWRE), the base station (GW) returns a receiving finish response to the terminal (TR). The terminal (TR) which receives response determines that transmission is finished (TRSO).

In a case where transmission is not finished (TRSO) after an elapse of a constant period of time (that is, the terminal (TR) does not receive response), the terminal (TR) determines a failure of data transmission. In this case, data is stored in the terminal (TR), and transmitted again in batch when a transmission state is established. Thereby, data can be acquired without losing data even in a case where a person who wears the terminal (TR) is moved to a location which wireless cannot be reached, or in a case where data is not received by a disorder of the base station (GW). Thereby, a property of an organization can be analyzed by obtaining a sufficient amount of data. The mechanism of storing data failed in transmission at the terminal (TR) and retransmitting the data is referred to as Batch Transmission.

An explanation will be given of a procedure of batch transmission of data. The terminal (TR) stores data which could not be transmitted (TRDM), and requests associate again after a constant period of time (TRTA2). Here, in a case where associate response is obtained from the base station (GW), the terminal (TR) converts data format (TRDF2), divides data (TRBD2), and transmits data (TRSE2). These processings are respectively similar to convert data format (TRDF1), divide data (TRBD1), and transmit data (TRSE1). Further, in transmitting data (TRSE2), a congestion control is carried out such that wirelesses dot collide with each other. Thereafter, the sequence returns to ordinary processings.

In a case where associate response is not obtained, the terminal (TR) stores newly obtained data (TRDM) by executing sensing (TRSS1) and adds external information and time information (TRCT1) periodically until succeeding in associate. Data acquired by these processings are stored in the terminal (TR) until receiving finish response is obtained from the base station (GW). Sensing data stored in the terminal (TR) is transmitted to the base station (GW) in batch (TRSE2) when an environment capable of executing transmission/reception to and from the base station (GW) is in order stably, for example, after succeeding associate, or when charged in the wireless circle, when connected to the base station (GW) by wire or the like.

Further, sensing data transmitted from the terminal (TR) is received (GWRE) by the base station (GW). The base station (GW) determines whether received data has been divided by a divided frame number attached to sensing data. In a case where the data is divided, the base station (GW) associates data (GWRC) and associates the divided data to continuous data. Further, the base station (GW) provides base station information (GWMG) which is a number inherent to the base station to sensing data (GWGT), and transmits the data to the sensor net server (SS) via the network (NW) (GWSE). The base station information (GWMG) can be utilized in analyzing data as information indicating an outline position of the terminal (TR) at the time.

When the sensor net server (SS) receives data from the base station (GW) (SSRE), the sensor net server (SS) classifies the received data to respective elements of time, terminal information, acceleration, infrared ray, temperature and the like (SSPB). The classification is executed by referring to the format which is recorded as the data format information (SSMF). The classified data is stored to a pertinent column (column) of a record (row) of the sensing database (SSDB) (SSKI). By storing data in correspondence with the same time to the same record, a search by the time and the terminal information (TRMT) can be executed. At this occasion, tables may be created for respective pieces of terminal information (TRMT) as necessary. The data reception (SSRE), the data classification (SSPB) and data storing (SSKI) are carried out at the sensing data store (SSCDB) in FIG. 3.

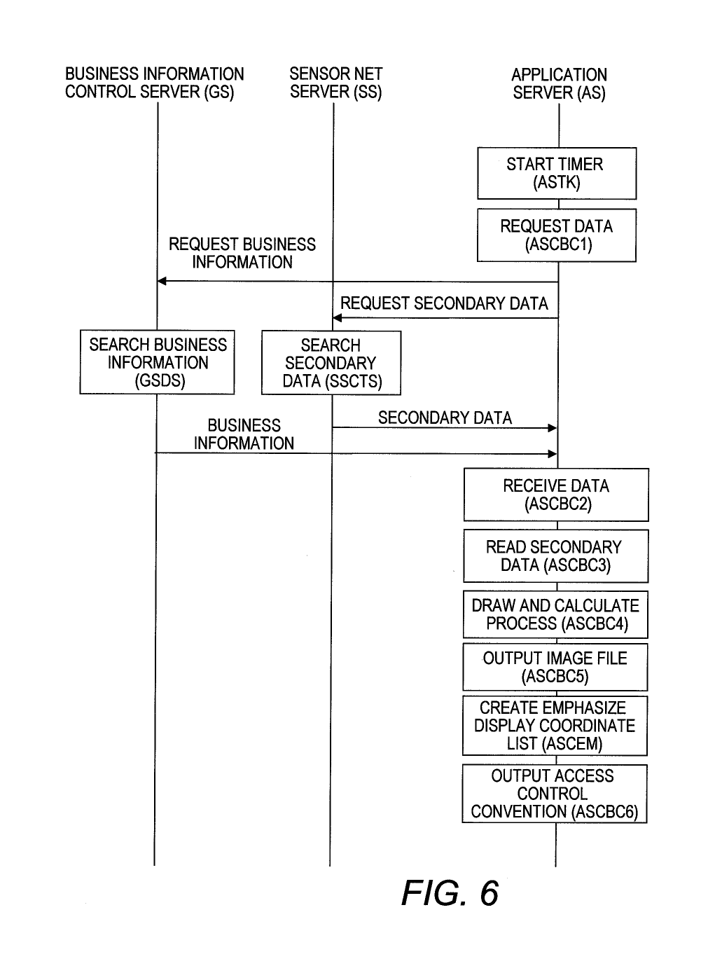

### <FIG. 6: Sequence of Basic Content Creation (ASCBC)>

FIG. 6 shows a sequence of processings of the basic content creation (ASCBC) which is executed in the application server (AS) of FIG. 2.

In the application server (AS), when the clock (ASCK) becomes previously designated time, the basic content creating program (ASBP) is started (ASTK). The basic content creating program includes plural kinds of programs, and plural kinds of the basic content files (ASBF) respectively in correspondence therewith may be outputted. Further, by designating an order of starting individual programs may be designated, and the basic content file (ASBF) outputted may be read and successively, other basic content file (ASBF) may be created. In this case, an explanation will be given of the sequence by assuming that there is one kind of the basic content.

The application server (AS) requests necessary data described in the basic content forming program (ASBP) to the sensor net server (SS) or the business information server (GS) or both thereof by designating an object time period and an object user (ASCBC1). The sensor net server (AS) searches in the secondary database (SSDT) based on the received request (SSCTS) and returns necessary data to the application server (AS). Also the business information control server (GS) executes business information search (GSDS) similarly based on the request, and returns the business information.

The application server (AS) receives the secondary data and the business information (ASCBC2). Further, the application server (AS) reads secondary data based on a data format by using the secondary data reading program (ASPR). The application server (AS) draws sensing data in a format which is easy to understand for a viewer by using the secondary data and business information as necessary. Or, the application server (AS) calculates an index or the like as numerical data (ASCBC4). The application server (AS) outputs an image file of drawn content (ASCBC5), and stores the image file as the basic content file (ASBF) in the memory module (ASME). Further, the application server (AS) outputs also the emphasize display coordinate list (ASEM) in drawing (ASCEM). This is a list describing a coordinate value on the image file which describes ID's of respective users and data related thereto and designates a way of emphasizing. For example, in a case of emphasizing by a rectangular broken line, left upper and right lower coordinate values are described in correspondence with the user ID. The application server (AS) outputs also the access control convention (ASAC) (ASCBC6), and designates the user ID which can view the image file created by the processing in the format of a logical equation or the like.

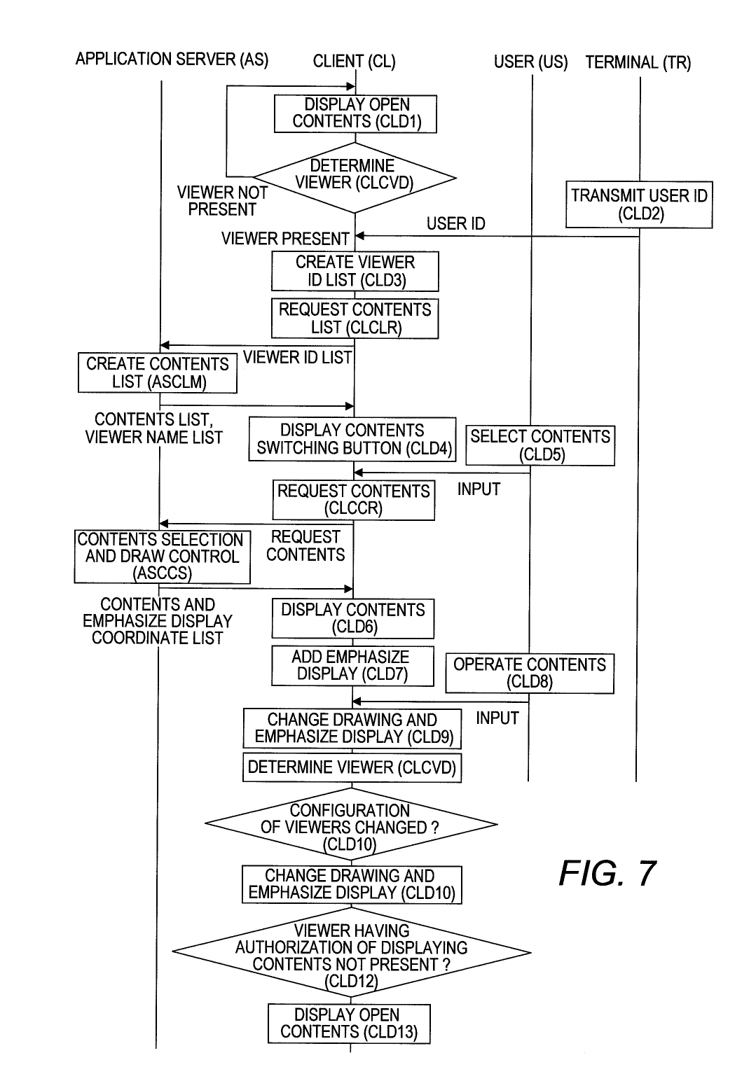

### <FIG. 7: Sequence of Displaying Content>

FIG. 7 shows a sequence when content, mainly, an image is displayed. The client (CL) ordinarily displays open content which can be viewed by anybody, (e.g. a network diagram which does not display an individual name, a message board, weather forecast acquired from the internet or the like) on the display (CLOD) (CLD1). The viewer detector (CLVD) is always brought into a standby state, and executes the viewer determination (CLCVD). In a case where it is determined that there is not a viewer, the client (CL) continues displaying the open content. In a case where the user ID which is transmitted from the terminal (TR) is received (CLD2), and it is determined that there is a viewer, the client (CL) creates the viewer ID list (CLD3), transmits the viewer ID list to the application server (AS), and requests a list of content which is viewable by a member configuration of current viewers (CLCCR). The application server (AS) refers to the content list (ASCL) and the access control convention (ASAC), extracts the list of content viewable by the member configuration of the viewers, and returns the list to the client (CL). Along therewith, the application server (AS) refers to the user attribute list (ASUL) and returns names of viewers. The client (CL) displays a content switching button (OD_C1) indicating a link to viewable content and a viewer selecting button (OD_A1) indicating names of viewers based on the content list (CLD4). Further, the client (CL) waits for selecting content by pressing down a button by the user (US) (CLD5). Or the client (CL) may display what is set as a default display on the display (CLOD) without waiting for the operation of the user (US). When the input by the user (US) is sensed, the client (CL) requests an image of selected content (or other kind of data) to the application server (AS) (CLCCR). The application server (AS) selects corresponding content in accordance with requested conditions (date of object, object user, content kind), and returns the content to the client (ASCCS). Along therewith, the application server (AS) also returns the emphasize display coordinate list (ASEM).

The client (CL) displays received content (CLD6) and adds an emphasize display by surrounding a coordinate value in correspondence with a current viewer by a rectangle or the like (CLD7). When the user operates the display (CLD8), the client (CL) changes a drawing or a position or a method of emphasize display in accordance therewith (CLD9). For example, when a specific user is selected by the viewer selecting button (OD_A1), the client (CL) executes a processing of winking only the emphasize display of the user, or enlarging to display centering on a display with regard to the user or the like. Further, the client (CL) executes the viewer determination (CLCVD) at constant periods of time. In a case where the member configuration of the viewers is determined to be changed (CLD10), the client (CL) changes Draw and emphasize display (CLD11). Specifically, there is a case where a name and an emphasize display of a viewer who is not present is not displayed, or a name and an emphasize display of a newly joined viewer is added. Further, in a case where by a change in the member configuration, a viewer who has an access authorization to content which are being displayed currently is not present and viewing authority is lost (CLD12), the open content are automatically displayed (CLD13) and the content switching button (OD_C1) which links to the displayed content is not displayed.

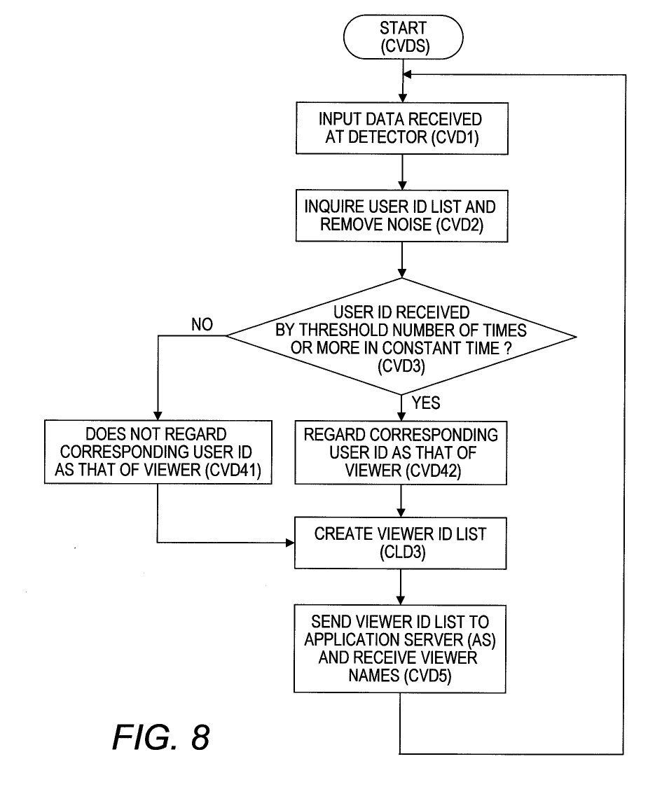

### <FIG. 8: Flowchart of the Viewer Determination>

FIG. 8 shows a flowchart of the viewer determination (CSCVD). The viewer determination (CSCVD) is a processing which is always operated during a time period in which the viewer detector (CLVD) is started.

After start (CVDS), an infrared ray data received from the detector is inputted (CVD1), the user ID list is inquired, and in a case where the infrared ray data is not an effective user ID described there, the data is determined as noise and removed (CVD2). Further, a number of times of receiving the user ID is counted by dividing time by a constant period of time, for example, every 1 second or 5 seconds. It is determined whether the number of times is equal to or more than a previously determined threshold number of times or more (CVD3), and the received user ID is regarded as of a viewer (CVD42). Otherwise, the user ID is not regarded as of a viewer (CVD41). This is because the user (US) who passes by only one moment is not included in the viewer. In this way, the list of the user ID which is regarded as of the viewer at that time is written (CVD3), and the viewer ID list is sent to the application server (AS) and respective names of the viewers are acquired (CVD5). The flow described above is repeated until the viewer determination (CSCVD) program is finished manually or by a timer.

### <FIG. 9: Display Example of Emphasize Display in Displaying Network Diagram>

FIG. 9 shows an example of an emphasize display. As content information displayed, a case of adopting a network diagram of an organization is used as an example. An image of a network diagram which is received from the application server (AS) is displayed at a content display area (OD_B) of a screen (OD) displayed on the display (CLOD) of the client (CL). An emphasize display is displayed by surrounding a portion related to a current viewer by a circle or the like in accordance with the emphasize display coordinate list (ASEM) which is received along therewith. Further, names of users who are detected as viewers currently are displayed at a viewer selecting button (OD_A1). When anyone of the viewers is selected, the emphasize display in correspondence with the name of the user may be winked, or a line kind may be changed. Further, in a network diagram of an organization having a large number of persons, one user is displayed to be small. Therefore, the image may be moved or enlarged to display such that a range of seeing the current viewer comes to a center of the content display area (OD_B).

### <FIG. 10: Display Example of Emphasize Display in Displaying Organization Index>.

FIG. 10 shows an example of an emphasize display. As content information to be displayed, there is used a case of adopting a bar graph which is aligned with an index by a unit of an organization as an example. In content display area (OD_B), a bar graph indicating a total meeting time of each section is arranged, and a portion of a bar in correspondence with a current viewer is surrounded by a bold line to emphasize. The emphasize display coordinate list (ASEM) is described with coordinate values showing positions of an organization in correspondence with respective users, and an emphasize display is carried out based thereon. Further, additional information can also be displayed. In the example of FIG. 10, it is shown who is to pay attention to which section by displaying a name of a viewer belonging to the section. Other additional information can be displayed. Further, in the example of FIG. 10, although a name of a section to which the current viewer belongs is displayed under the bar graph, a name of other section is erased. In this way, information which is not related to the viewer may be deleted by the emphasize display (CLCEM). Thereby, as a statistic comparison object, information of a section or a person which is not related to the viewer can be presented without specifying an unrelated other person. Further, it is one of effects that thereby, the name of the section to which the viewer belongs is emphasized.

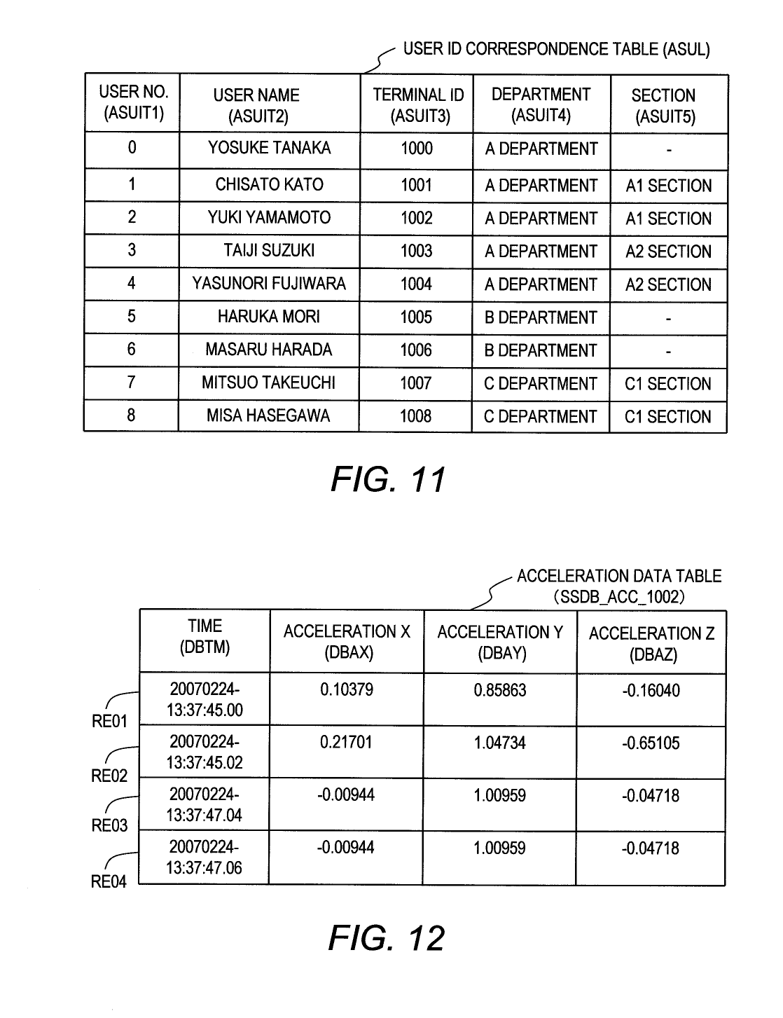

### <FIG. 11: Example of User ID Correspondence Table (ASUL)>

FIG. 11 is an example of a format of a user ID correspondence table (ASUL) which is stored in the memory module (ASME) of the application server (AS). The user ID correspondence table (ASUL) is recorded with user number (ASUIT1), user name (ASUIT2), a terminal ID (ASUIT3), and a department (ASUIT4) or a section (ASUIT5) to which a user belongs, by being related to each other. The user number (ASUIT1) indicates a consecutive number of an existing user. Further, the user name (ASUIT2) indicates a name or a nickname of the user (US) which is used in creating a screen or content, and the terminal ID (ASUIT3) indicates terminal information of a terminal (TR) which is owned by the user (US). The user and the terminal ID (ASUIT3) specifically correspond to each other in a one-to-one relationship. Further, the department (ASUIT4) or the section (ASUIT5) is a piece of information of an organization to which the user (US) belongs. For example, in a case where basic content are formed by a unit of an organization, a member included in data is specified based on the information.

Further, although the information of the user and the organization to which the user belongs is defined by a format of a table in FIG. 11, the information may be shown hierarchically by using XML or the like. In that case, the information can be described in accordance with an organization hierarchy such that A department is present under A cooperation, or A1 section is present under A department, and a user name or a terminal ID or the like of an individual can be described in a corresponding organization. Further, the same person can actually belong to plural systems concurrently, and therefore, plural organizations may correspond to one user.

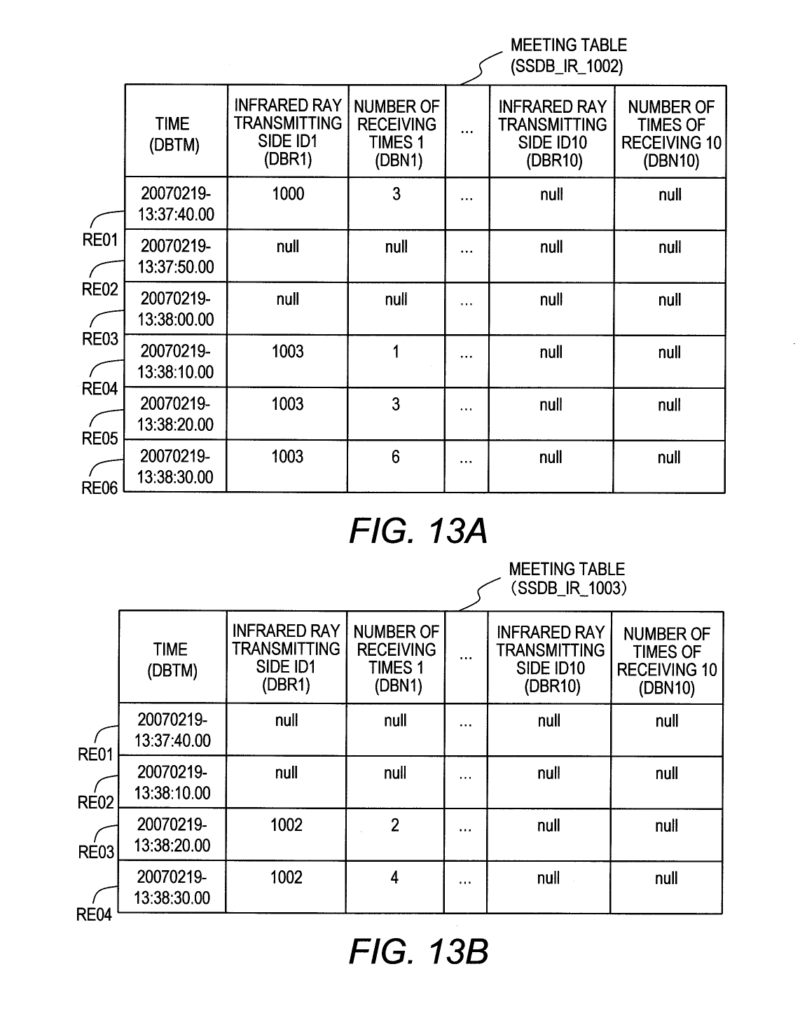

### <FIG. 12: Example of Sensing Database (SSDB): Acceleration Data Table>

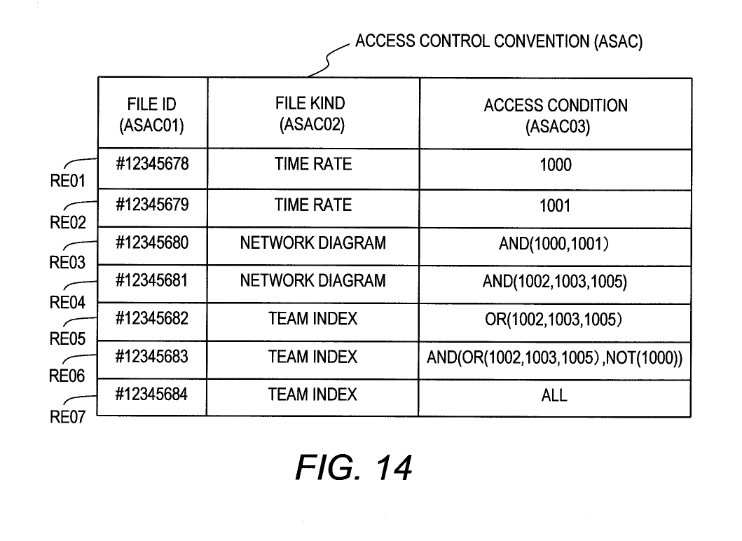

FIG. 12 shows an example of an acceleration data table (SSDB_ACC_1002) as an example of sensing data stored to the sensing database (SSDB) in the sensor net server (SS). This is basically sensing data as it is acquired at the terminal (TR), and data in a state of not being subjected to preparation. The table is formed for each individual, and the table is stored with respective acceleration data in triaxial directions of X axis (DBAX), Y axis (DBAY), and Z axis (DBAZ) in correspondence with the time information (DBTM) at every sampling period (e.g. 0.02 second). Further, an original numerical value which is detected by an acceleration sensor may be stored, or a value after converting a unit thereof to [G] may be stored. The acceleration data table is created for each member, and stored in correspondence with information of time of sensing. Further, when a column indicating user ID is added, the table may be unified without being divided for respective individuals.

<FIGS. 13A and 13B: Examples of Sensing Database (SSDB): Meeting Tables>

Although the sensing database (SSDB) is recorded with plural kinds of sensing data of plural members, FIGS. 13A and 13B show examples of tables summarizing meeting data by transmission/reception of an infrared ray thereamong. FIG. 13A is a meeting table (SSDB_IR_1002), and assumes a table which collects data acquired by the terminal (TR) having a terminal ID of 1002. Similarly, FIG. 13B is a meeting table (SSDB_IR_1003) and assumes a table which collects data acquired by the terminal (TR) having a terminal ID of 1003. Further, when a column is added with an infrared ray receiving side ID, the table may not be divided for each acquired terminal (TR). Further, other data of acceleration, temperature and the like may be included in the same table. Further, also the detector ID (CLVDID) which is received from the infrared ray transmitter receiver (CLVDIR) of the viewer detector (CLVD) may be put into the infrared ray transmission side ID (DBR) similar to the user ID received from the terminal (TR). In this case, by searching the table with the detector ID as a key, it can be investigated who has viewed display at which location.

The meeting tables of FIGS. 13A and 13B are an example of storing 10 sets (DBR1 through DBR10, DBN1 through DBN10) of times (DMTM) of transmitting data by the terminal (TR) and the infrared ray transmitting side ID (DBR1) and a number of times of receiving from the ID (DBN1). In a case where data transmission is carried out once per 10 seconds, the table shows by what number of times infrared rays are received from which terminal (TR) during 10 seconds after transmission at a preceding time. Even in a case where the plural terminals (TR) meet in 10 seconds, the data can be stored up to 10 sets. Further, the number of sets can freely be set. In a case where meeting, that is, reception of an infrared ray is not present, a value of the table becomes null. Further, although in FIGS. 13A and 13B, time is described down to millisecond, any format of time will do so far as the format of time is unified.

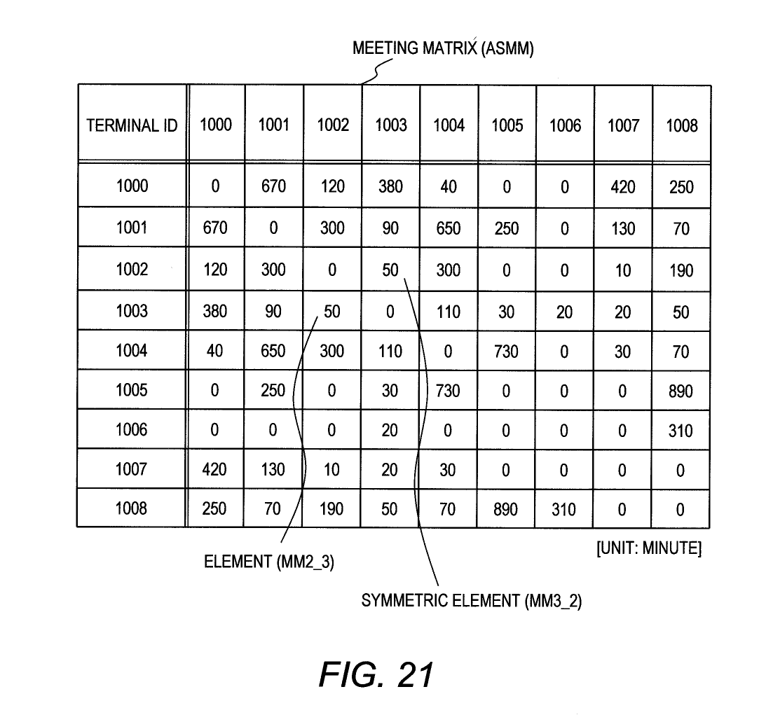

### <FIG. 21: Example of Secondary Database (SSDT): Meeting Matrix>

FIG. 21 shows an example of a meeting matrix (ASMM) as an example of the secondary database (SSDT) which stores a result of the sensing data processing (SSCDT) in the sensor net server (SS). The secondary database is a database of storing information of a specific user in a constant period of time by a common format after finishing underprocessing.

FIG. 21 shows an example of the meeting matrix (ASMM) showing total meeting time in a time period between arbitrary members of a certain organization. A meeting matrix is referred to as an adjacent matrix in a technical term of network analysis. The meeting matrix (ASMM) calculates total meeting time between members of an arbitrary combination based on the meeting table (SSDB_IR) and is arranged in a matrix format. According to the meeting matrix shown in FIG. 21, an element (MM2_3) and a symmetric element (MM3_2) show that a user of a user number 2 and a user of a user number 3 meet for 50 minutes. A file format of the meeting matrix may be text, or respective columns of database may correspond to user ID's of the two members. When the total meeting time is calculated from the meeting table (SSDB_IR), it is preferable that the time is not summed up as it is, but values after correcting time at which the meeting is not carried out may be summed up. Further, although in FIG. 21, the meeting matrix (ASMM) is a symmetric matrix, the meeting matrix may be made to be an asymmetric matrix depending on a processing method.

It is preferable that the meeting matrix (ASMM) does not sum up the meeting time by only using the meeting table (SSDB_IR), but the acceleration data tables (SSDB_ACC) of two users at time of meeting may be referred to, the meeting may be regarded to be carried out only in a case where the acceleration(s) of the two persons or at least one of the persons is (are) a value (values) equal to or more than a threshold, and the meeting time in this case may be added to time counting. Thereby, only effective data can be recorded in the meeting matrix by regarding that the two persons communicate each other by excluding time in a case where the terminal (TR) is left and infrared rays are transmitted and received, or a case where the two persons do not communicate each other and are only seated from the meeting time. Further, the above processing may be carried out by using not the acceleration data table (SSDB_ACC) but a rhythm of a motion rhythm tapestry (AADS_ACCTP).

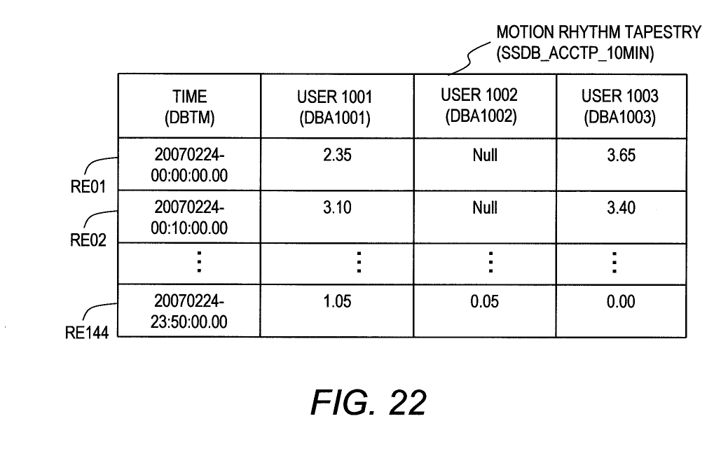

Further, the meeting matrix (ASMM) may be provided with a threshold of meeting time per day and the number of days on which the meeting time exceeds the threshold in a time period may be made to be a value of the element. In this case, when a conversion is carried out between two persons by a large amount of information in one day, the persons are regarded to link with each other.

<FIG. 22: Example of Secondary Database (SSDT): Motion Rhythm Tapestry>

FIG. 22 shows an example of motion rhythm tapestry (SSDB_ACCTP_{—}10 min) as an example of the secondary database (SSDT). The motion rhythm tapestry (SSDB_ACCTP_{—}10 min) calculates a frequency at every 10 minutes (which is referred to as motion rhythm) in the example of FIG. 22 at every constant time of each user (US), at every 10 minutes in the example of FIG. 22, based on the acceleration data table (SSDB_ACC), and times at every 10 minutes and a user ID are corresponded and stored to the table. Further, a format of storing the data may use other method of CSV file or the like other than the table. In order to calculate the motion rhythm, the motion rhythm may be calculated by summing up the number of zero cross times of three axes of XYZ per time unit. Further, in a case where a data is deficient or determined to be impertinent, a sign of “Null” or the like may be attached to the data, showing that the data cannot be used in the basic content creation (ASCBC). Further, otherwise, when several ways of the motion rhythm tapestries (SSDB_ACCTP) having different time units are created at the sensor net server (SS), various content can be created by combining these, and therefore, the motion rhythm tapestries are useful.

In this way, when the basic content creation program (ASBP) of the application server (AS) is developed by carrying out preparation by the sensing data processing (SSCDT) at the sensor net server (SS), the basic content creation program (ASBP) can be developed without being conscious of a characteristic of the sensing data or a method of the underprocessing.

By specifying a current viewer and emphasizing to display a portion related to the viewer by a method described in the first embodiment, the viewer can be made to be able to pay attention swiftly to information having a high priority. Further, the method contributes also to accelerate conversation by comparing the method among the viewers.

### Second Embodiment

An explanation will be given of second embodiment of this invention in reference to the drawings. In a second embodiment, an explanation will be given of a mechanism necessary for restricting content information which can be viewed by a member configuration of the viewers. Thereby, viewers are restricted, and therefore, it is easy to deal with secret information. An explanation will be omitted of a portion which is duplicated with first embodiment.

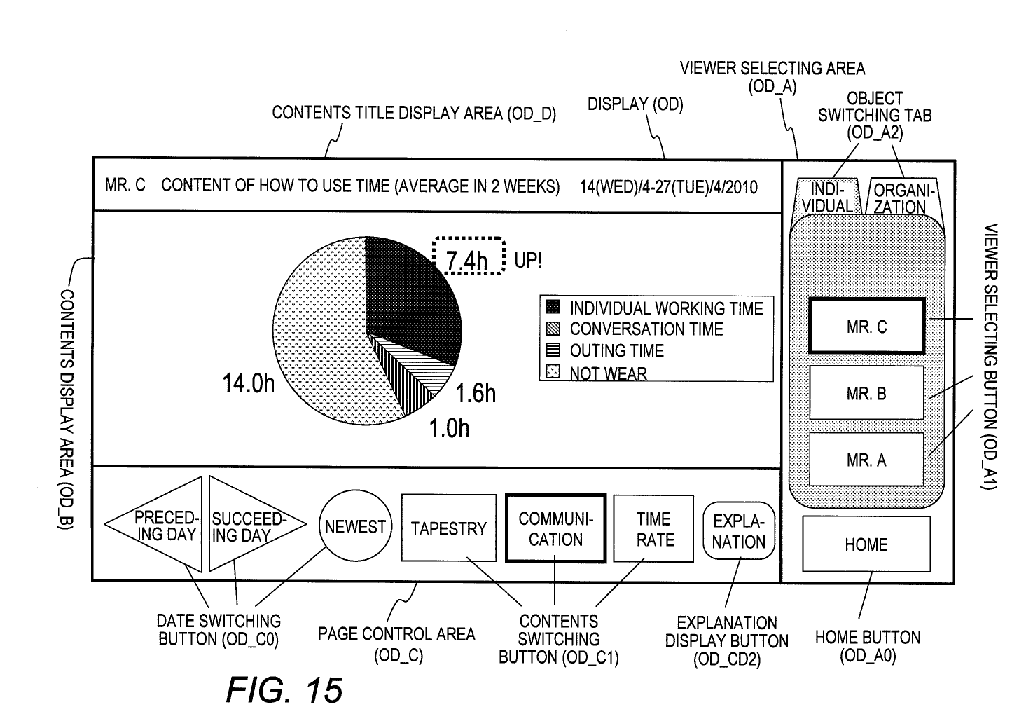

### <FIG. 14: Access Control Convention (ASAC)>

FIG. 14 shows an example of the access control convention (ASAC) file. The access control convention (ASAC) is outputted in creating the basic content (ASCBC) of the application server (AS) along therewith, and is described with a condition of capable of making an access to the corresponding basic content file (ASBF). For example, an access condition is defined such that a file related to a certain department or a section can be viewed in a case where at least one person of members of the department or the section is included in viewers.

In the access control convention (ASAC), a file ID (ASAC01), a file kind, (ASAC02), and an access condition (ASAC03) of the basic content file are defined in correspondence with each other. Further, when the file can be identified individually by an ID, the file kind (ASAC02) may be omitted. The file ID (ASAC01) is an ID attached individually to a file which is outputted by the basic content creation (ASCBC), even the contents of the same kind are assigned with other ID when an object period or an object member of data differs. For example, in a case of a network diagram, although an access authorization is given to all of members of a department in a diagram with the department as an object, the access authorization is given only to members of a section in a diagram with a section as an object. In this way, the access convention can be determined in correspondence with an individual file.

The file kind (ASAC02) shows a kind of content. The file kind is used for an index, or a classification when buttons are displayed in content switching buttons (OD_C1).

The access condition (ASAC03) shows a user ID of a viewer which is necessary for displaying a corresponding file by a logical equation. In a case where the access condition is shown by AND as in rows (RE03, RE04), a display authorization is not issued unless all of viewers in correspondence with the user ID's are detected simultaneously. Further, when the access condition is shown by OR as in row (RE05), the display is authorized so far as at least one thereamong is detected as the viewer. Further, the display authorization can be restricted not to be issued when a specific user is viewing by using a condition of NOT as in row (RE06). The display authorization can be issued to all members, that is, the content can also be defined as open content as in row (RE07).

In this way, by defining display authorization by a logical equation, a display condition can be given to an individual file. Thereby, when the member configuration of viewers is changed, a file which can be viewed is also changed, and therefore, a motivation of intending to view along with other members can be accelerated.

### <FIG. 15: Basic Configuration Display>

FIG. 15 shows an example of a screen (OD) in a case where content are displayed at the client (CL). The display is controlled by the input/output control (CLCIO).

The display (OD) is grossly divided into 4. That is, the display (OD) is divided into a viewer selecting area (OD_A), a page control area (OD_C), a content display area (OD_B), and a content title display area (OD_D). A way of an operation in receiving an input can be changed in the respective areas. Further, these may be provided with 4 functions, and therefore, the areas may not absolutely be divided but buttons satisfying the respective functions may be displayed when the input is carried out by a specific location or an operation.

The content display area (OD_B) is an area which is fitted with an image of the basic content file (ASBF) that is called from the application server (AS) or a display which can be operated by Servlet or the like. An emphasize display can also be applied to a portion in correspondence with a current viewer based on the emphasize coordinate display list (ASEM). In the example of FIG. 15, an elevated index is emphasized by being surrounded by a rectangular broken line. By dragging inside of the content display area (OD_B) by a touch panel or a mouse, a date can be switched to a preceding day, content can be switched, or an operation of the date switching button (OD_CO) or the content switching button (OD_C1) can be substituted. Further, by pointing inside of the content display area (OD_B) by a touch panel or a mouse, a specific portion can be enlarged to display, or an image can also be moved such that a specific portion comes to a center.

The content title display area (OD_D) is an area which presents information with regard to content displayed on the content display area (OD_B) currently. Specifically, an object user or an object system, a kind of content, and an object time period are displayed by characters.

The viewer selecting area (OD_A) is an area for displaying a name of a viewer who is detected currently and switching an object person of content displayed on the content display area (OD_B). An object switching tab (OD_A2) is a tab for switching selection of content by a unit of an individual or a unit of organization. When “individual” is selected, a viewer selecting button (PD_A1) is displayed in the tab, and a name of a user who is determined as a viewer by the viewer determination (CLCVD) currently is displayed. By selecting either thereof, or plural viewer selecting buttons (PD_A1), an object person of content displayed can be switched. A home button (OD_A0) is a button for returning to display an initial set by default. For example, the default is designated with open content having no viewing restriction with the newest date. Shortcutting can be carried out by designating what has a high frequency of viewing. In a case where the current display is not intended to be viewed by other person who is passing by, the default can be used for a use of concealing the display.

The page control area (OD_C) displays buttons for updating a screen by changing a condition of content displayed. By the date switching button (OD_C0), the content displayed of a preceding date, that of a succeeding date, or that of a newest can be switched. Only an object time period of content is changed, the kind of content, the object user or the object system are not changed. Thereby, a time-sequential change of the same content can be analyzed by a viewer. The content switching button (OD_C1) is for selecting the kind of content. A name of content included in a content list having a viewing authorization which is received from the application server (AS) is displayed as a button. By not displaying, or invalidating a button of content which has no authorization of viewing, the viewer is restricted so as not to make access to content which have no authorization. Content currently displayed are displayed by changing a color of the button. Further, an explanation display button (OD_C2) is a link to an explanation display of content currently displayed. The explanation display is written with an explanation of a way of viewing content display, a point of paying attention, a method of calculation and the like.

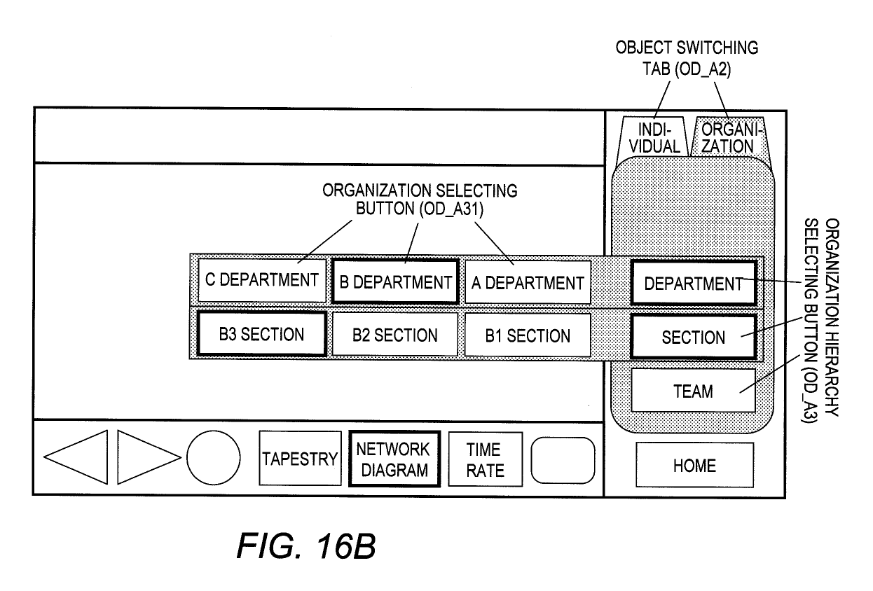

### <FIGS. 16A and 16B: Display (in Selecting Content)>

FIGS. 16A and 16B show examples of operations of a content switching button and an organization selecting button for selecting content.

FIG. 16A shows a method of classifying content and assigning the content to buttons in a case where there are many kinds of content. Content switching buttons (OD_C1) are indicated with a classification of content, for example, time rate, communication, tapestry and the like, and in a case where any one thereof is selected, a name of a lower grade content of the classification is displayed as a sub content selecting button (OD_C11). The user can designate content by selecting any of the sub content selecting button (OD_C11).

FIG. 16B shows a method of assigning buttons such that an organization can be selected hierarchically when an object organization of content is selected. A system hierarchy, for example, department, section, team and the like are displayed on a system hierarchy selecting button (OD_A3), and in a case where any of these is selected, an organization selecting button (OD_A31) is displayed, and a name of an organization belonging to the hierarchy is selected. In a case where a lower grade organization is intended to select, one grade lower hierarchy of the organization hierarchy selecting button (OD_A3) is displayed with a name of a system of the lower grade organization. By enabling to select hierarchically in this way, an access can be made swiftly to information of an aimed organization.

By the method described in the second embodiment, a current viewer can be specified, and a restriction can be imposed such that an access can be made only to a page which is related to a viewer. Thereby, a viewer can be made to pay attention swiftly to information having a higher priority. When viewers are increased, viewable content are increased, and therefore, an effect of urging to view data by conversing together is also achieved. Further, other person cannot sample sensing data of a person without presence of the subject person and without a permission of the subject person, and therefore, an assurance in view of security is felt.

### Third Embodiment

An explanation will be given of a third embodiment of this invention in reference to the drawings. In the third embodiment, an explanation will be given of a mechanism in which a mail of content related to sensing data is sent to a user (US), a reply result is displayed on the display (CLOD) in a list, and the content can be shared by viewers. An effect of accelerating to share information is also achieved by forming content of a mail by using sensing data. An explanation will be omitted of a portion which is duplicated with the first embodiment.

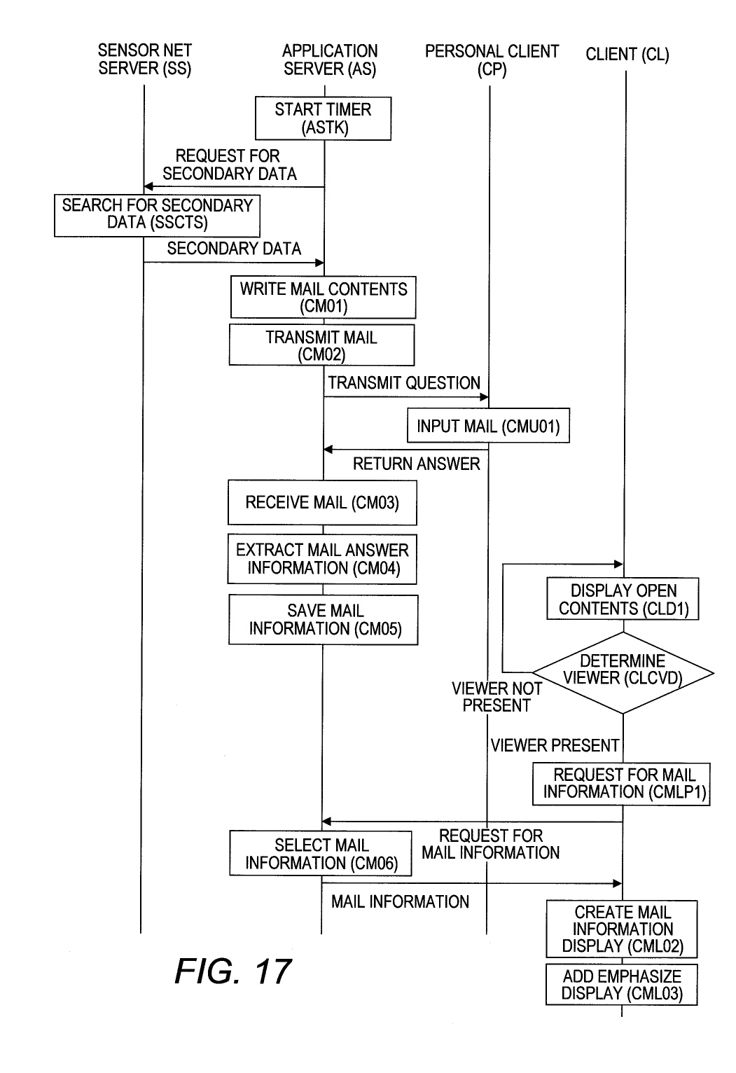

### <FIG. 17: Sequence of Mail Transmitting/Receiving Mail and Displaying Display>

FIG. 17 shows an example of a sequence in which the application server (AS) transmits a mail to the personal client (CP), and there is displayed a result of posting to reply to the mail by the users (US) or the like on the display (CLOD).

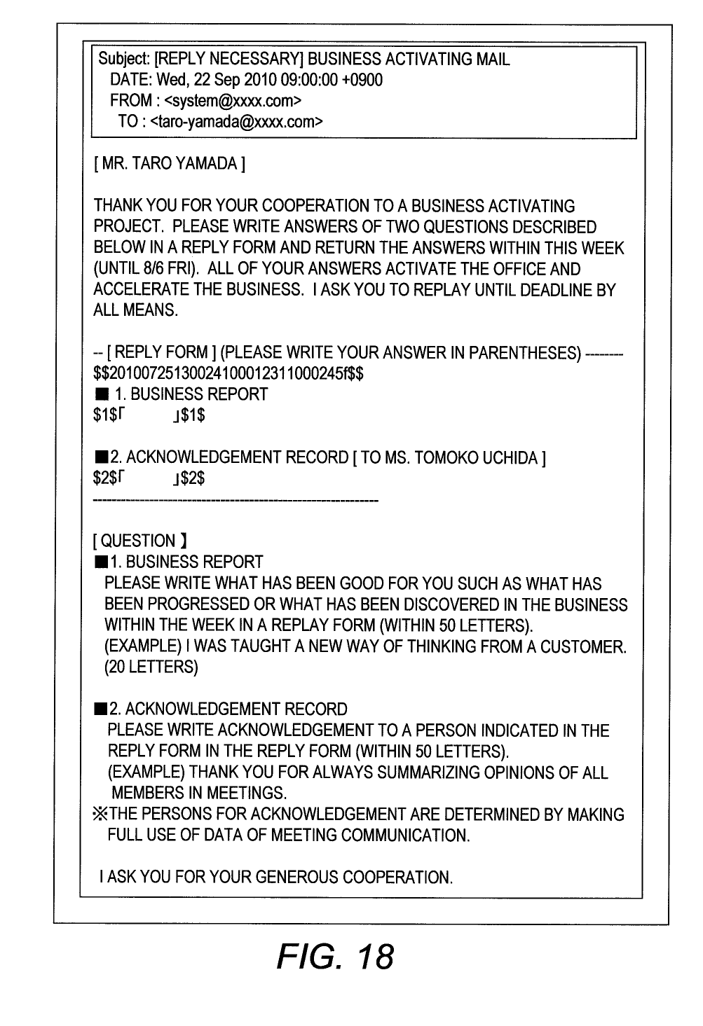

A mail content forming program (not illustrated) in the memory module (ASME) is started by timer start (ASTK) at a previously designated time, for example, a specific time of once per day or once per week. The program requests secondary data to the sensor net server (SS) and receives returned data. As secondary data requested here, there is acquired data or the like indicating time of making a communication between persons of an arbitrary combination in a constant period of time in the past by using, for example, the meeting matrix (ASMM) or the like. Next, information of the secondary data is embedded to a format of a mail and content of the mail are created (CM01). FIG. 18 shows an example of content of a mail. The example shows content urging the user who is a transmission destination of the mail to embed a name of a person who has communicated with the user frequently during a constant period of time in the past and write an acknowledgement item in business to the person. By the method, questionnaires can be collected and opinions can be collected efficiently based on the sensing data.

Here, as an example of naming an opposite party to which an acknowledgement item is written based on the meeting matrix (ASMM) in creating content of the mail (CM01), a method thereof will be described. First, a threshold is provided to the meeting matrix (ASMM), and persons who are at and above the threshold are defined as “being linked”.

With regard to an object time period, for example, in a case where a frequency of executing mail transmission is once per week, a data time period which is made to be an object of calculating the meeting matrix is set to two weeks. In this way, when a duplication of a data time period with that in transmission at a preceding time is reduced, data of the meeting matrix is changed from that at a preceding time, and there is a high possibility that the object opposite party of acknowledgement becomes a different opposite party. Further, when an explanation is added for supplementing an image, “being linked” designates persons who are connected directly by a line in a network diagram (what is described as an example of content in FIG. 9).

As a next procedure, reaching path numbers are calculated between persons of all of combinations. The reaching path number is an index showing by what times at minimum an opposite party is reached by tracing persons who are “being linked”, that is, lines connected therebetween in the network diagram. Further, combinations of acknowledging persons and opposite parties of acknowledgement are determined based on the reaching path number. Here, a mail with regard to a person who is not linked with anybody is not created, and the person is not included also as an object person of an opposite party of acknowledgement in a mail of other person. In determining an opposite party of acknowledgement, a priority is established, and an acknowledgement is distributed such that all object persons are selected as the opposite parties of acknowledgement as evenly as possible. Further, in a case where an acknowledgement mail is transmitted periodically, logs of opposite parties of acknowledgement in the past are preserved, and an acknowledgement is distributed such that, for example, an opposite party of acknowledgement does not overlap an opposite party of acknowledgement who has been acknowledged twice in the past. A priority of selecting an opposite party of acknowledgement is determined as, for example, (1) a person whose reaching path number is one path and who is not an opposite party of acknowledgement who has been acknowledged twice in the past, (2) a person whose reaching path number is two paths and who is not an opposite party of acknowledgement who has been acknowledged twice in the past, (3) a person who is an opposite party of acknowledgement whose reaching path number is one paths and who is an opposite party of acknowledgement at a time preceding to a preceding time, (4) a person who is the opposite party of acknowledgement whose reaching path number is one path and who is an opposite party of acknowledgement at a preceding time, (5) a person who is an opposite party of acknowledgement whose reaching path number is two paths and who is an opposite party of acknowledgement at a time preceding to a preceding time, (6) a person who is an opposite party of an acknowledgement whose reaching path number is two paths and who is an opposite party of acknowledgement at a preceding time, (7) a person who is an opposite party of acknowledgement whose reaching path number is three paths.

In this way, an opposite party of acknowledgement at a current time is distributed evenly to a total of an organization based on data of the Meeting Matrix (ASMM) and acknowledgement opposite party log in the past. A probability of sending acknowledgements to the respective users per se is increased by distributing acknowledgements evenly, acknowledgements are sent from view points of various persons by avoiding duplication with acknowledgements in the past, and based on the meeting data, a meaningful acknowledgement in compliance with an actual situation is sent from a deeply linked person automatically, as an effect thereof.

The created content to the individual user (US) are transmitted to respective mail addresses (CM02). The user (US) receives the mail by a personal client or a PC or the like owned by an individual, inputs an answer and returns the mail (CMU01).

When the application server (AS) receives the mail (CM03), the application server (AS) extracts only a portion related to the answer from a text of the returned mail (CM04). In the extraction, the portion may be cut out in reference to specific signs embedded before and after an answer column, or may be cut by looking at a difference from a format of an original mail. Extracted answer information of the user (US) is stored as mail information (ASBF) in correspondence with additional information of a date of transmitting the original mail, a date of answering from the user and the like (CMOS).

On the other hand, in order to view information recovered from the user (US), by way of transmitting/receiving the mail as described above, the display (CLOD) of the client (CL) is used. A mechanism of dealing with mail information, displaying the mail, and detecting a viewer as one of content displayed is similar to those of first embodiment and second embodiment.

During a time period in which the viewer is not present, the client (CL) displays open content (CLD1). When it is determined that the viewer is present (CLCVD), and content related to the mail is selected, the mail information (ASBF) related to the viewer is requested to the application server (CML01). The application server (AS) selects the requested mail information, and returns the mail information to the client (CL) (CM06). The client (CL) creates a screen which is combined with a text of the mail information by the input/output control (CLCIO) as necessary (CML02), and displays the screen on the display. Further, when needed, an emphasize display is added (CML03). For example, a difference from yesterday is investigated, and content of newly received mail are emphasized.

FIG. 19 shows an example of a screen reflecting a replay result by a mail. In addition to data related to a designated viewer (circular graph on the left side, a business report which is answered by the viewer per se is displayed at an upper portion on the right side. The content of acknowledgement which answers with regard to the person by other person are displayed at a lower portion on the right side. Further, the newly received content may be added with an emphasize display.

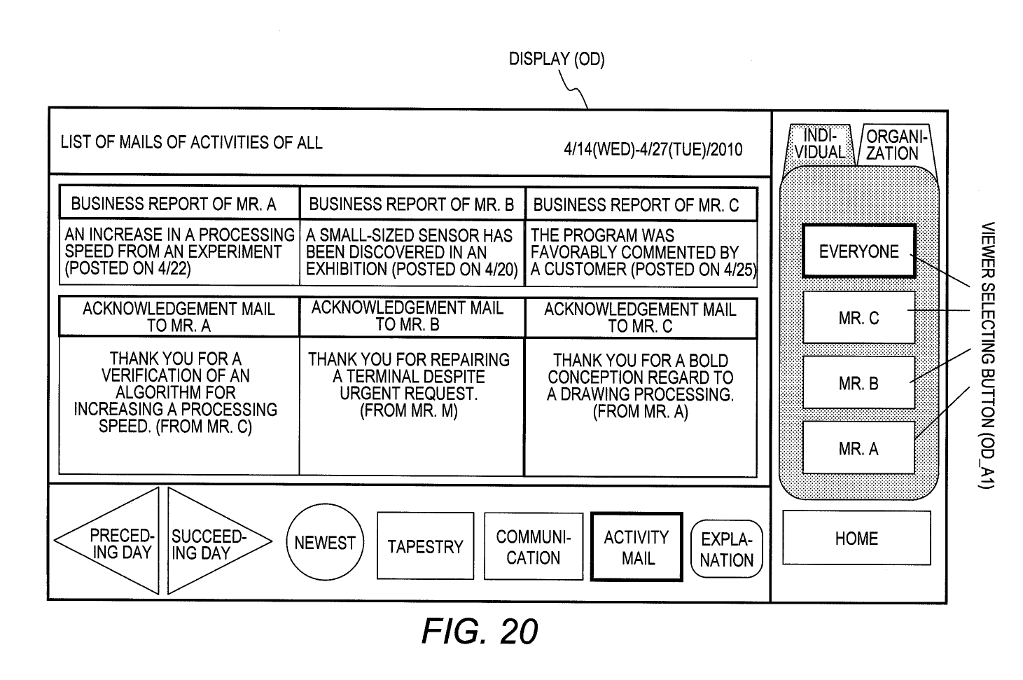

FIG. 20 shows an example of a screen creating a list with regard to all of viewers at the time point from a reply result by a mail. At this occasion, for example, a viewer selecting button (OD_A1) may be displayed with buttons selecting not only a name of an individual but summarizingly names of all viewers (in the drawing, a button of “Everyone”). Thereby, when all the members are requested to be displayed on the list, information of a mail with regard to all the viewers is acquired from the application server (AS), and in the input/output control (CLCIO), text information of these is arranged, and displayed as the screen (OD). By arranging and displaying the content in this way, all the viewers converse with regard to the description, and the information is easy to be shared.

By a method described in third embodiment, the questionnaire to the user (US) can be created based on the sensing data. Further, the text recorded by the user (US) can be displayed in the list by the display and viewed simultaneously by plural viewers. At that occasion, content related to the viewers are predominantly displayed, and therefore, an effect of urging conversation or review is achieved.

What is claimed is:

1. A sensing data display apparatus which displays a sensing data with regard to a human, the sensing data display apparatus comprising:
a receiving module for receiving a data indicating a physical amount detected by a sensor terminal mounted by the human;
a sensing data storing module for storing the data indicating the physical amount;
an information creating module for creating a piece of information related to the sensor terminal from the data stored to the sensing data storing module;
a display module for displaying the piece of information; and
a viewer detecting module for detecting a viewer who locates at a vicinity of the sensing display apparatus,
wherein the display module displays the piece of information related to a piece of information of the viewer detected by the viewer detecting module.

2. The sensing data display apparatus according to claim 1,
wherein the display module emphasizes to display a portion related to the viewer in the piece of information based on the piece of information of the viewer.

3. The sensing data display apparatus according to claim 2,
wherein the display module emphasizes the display by not displaying a portion which is not related to the viewer in the piece of information of the viewer based on the piece of information of the viewer.

4. The sensing data display apparatus according to claim 2,
wherein the display module emphasizes the display by enlarging the display of the portion related to the viewer.

5. The sensing data display apparatus according to claim 1, further comprising:
a determining module for determining whether the piece of information created by the information creating module can be viewed based on the piece of the information of the viewer,
wherein the display module displays the piece of information determined to be able to be viewed by the determining module.

6. The sensing data display apparatus according to claim 5,
wherein the display module provides a screen transition function for displaying the piece of information determined to be able to be viewed by the determining module.

7. The sensing data display apparatus according to claim 1, further comprising:
an identifier receiving module for receiving a piece of identifier information transmitted by an inherent identifier transmitter mounted by the human,
wherein the viewer detecting module detects the viewer based on the piece of identifier information received by the identifier receiving module.

8. The sensing data display apparatus according to claim 7,
wherein the inherent identifier transmitter and the sensor terminal are provided by the same terminal.

9. The sensing data display apparatus according to claim 7,
wherein the viewer detecting module detects viewing of the viewer specified by the piece of identifier information in a case where the piece of identifier information is not received within a predetermined period of time, after receiving the piece of identifier information.

10. The sensing data display apparatus according to claim 1,
wherein the display module has a transition function of finishing displaying the piece of information related to the viewer who is detected not to be present at the vicinity of the sensing data display apparatus by the viewer detecting module.

11. The sensing data display apparatus according to claim 5, further comprising:
a sensor terminal user database for relating and storing at least a piece of identifier information of the terminal, and a name and an electronic mail address of a user who wears a sensor terminal including the terminal;
an evaluating object specifying module for specifying other sensor terminal faced by the terminal by a predetermined frequency or more based on the data;
a comment request mail transmitting module for specifying a name of a user mounted with the other terminal from the sensor terminal user database based on a piece of identifier information of the other terminal specified by the evaluating object specifying module at the electronic mail address of the user of the terminal recorded to the sensor terminal user database based on the piece of identifying information of the terminal and transmitting an electronic mail requesting a comment to the user mounted with the other terminal; and
a comment storing module for receiving a reply to the electronic mail, and preserving a comment to the user mounted with the other terminal by relating the comment to the piece of identifier information of the other terminal,
wherein the display module displays the comment to the user mounted with the terminal stored to the comment storing module.

12. A sensing data processing system which collects, analyzes and displays a sensing data with regard to a human, the sensing data processing system comprising:
a sensor terminal of which the human wears; and
a sensing data display apparatus coupled to the sensor terminal by a network,
wherein the sensing data display apparatus comprises:
a receiving module for receiving a data indicating a physical amount detected by the sensor terminal;
a sensing data storing module for storing the data indicating the physical amount;
an information creating module for creating a piece of information related to the terminal from the data stored to the sensing data storing module;
a display module for displaying the piece of information; and
a viewer detecting module for detecting a viewer who locates at a vicinity of the sensing data display apparatus;
wherein the display module displays the piece of information related to a piece of viewer information detected by the viewer detecting module.
